(19) United States
(12) Patent Application Publication
(10) Pub. No.: US 2022/0073769 A1
(43) Pub. Date: Mar. 10, 2022

(54) INKJET INK FOR TEXTILE PRINTING

(71) Applicant: Hewlett-Packard Development Company, L.P., Spring, TX (US)

(72) Inventors: Jeffrey M. Stubbs, San Diego, CA (US); Zhang-Lin Zhou, San Diego, CA (US); David Michael Ingle, San Diego, CA (US)

(73) Assignee: Hewlett-Packard Development Company, L.P., Spring, TX (US)

(21) Appl. No.: 17/417,800

(22) PCT Filed: May 30, 2019
(86) PCT No.: PCT/US2019/034547

§ 371 Date: Jun. 24, 2021

(51) Int. Cl. C09D 11/322; C09D 11/106; C09D 11/033; C09D 11/037; D06P 5/30; D06P 1/52

(52) U.S. Cl. CPC C09D 11/322; C09D 11/106; D06P 1/525; C09D 11/037; D06P 5/30; C09D 11/033

(57) ABSTRACT

An example of an inkjet ink for textile printing includes a pigment, latex binder particles, and a liquid vehicle. The latex binder particles include: a single copolymer phase including a first carboxylic acid functional monomer and a first (meth)acrylamide functional monomer; or multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases.

### BACKGROUND

Textile printing methods often include rotary and/or flat-screen printing. Traditional analog printing typically involves the creation of a plate or a screen, i.e., an actual physical image from which ink is transferred to the textile. Both rotary and flat screen printing have great volume throughput capacity, but also have limitations on the maximum image size that can be printed. For large images, pattern repeats are used. Conversely, digital inkjet printing enables greater flexibility in the printing process, where images of any desirable size can be printed immediately from an electronic image without pattern repeats. Inkjet printers are gaining acceptance for digital textile printing. Inkjet printing is a non-impact printing method that utilizes electronic signals to control and direct droplets or a stream of ink to be deposited on media.

### BRIEF DESCRIPTION OF THE DRAWINGS

Features of examples of the present disclosure will become apparent by reference to the following detailed description and drawings.

FIGS. 1A through 1C are schematic illustrations of examples of the particles disclosed herein including multiple copolymer phases;

FIG. 2 is a flow diagram illustrating an example of a printing method; and

FIG. 3 is a schematic diagram of an example of a printing system.

### DETAILED DESCRIPTION

The textile market is a major industry, and printing on textiles, such as cotton, polyester, etc., has been evolving to include digital printing methods. However, the vast majority of textile printing 95%) is still performed by analog methods, such as screen printing. Multi-color printing with analog screen printing involves the use of a separate screen for each color that is to be included in the print, and each color is applied separately (with its corresponding screen). In contrast, digital inkjet printing can generate many colors by mixing basic colors in desired locations on the textile, and thus avoids the limitations of analog screen printing.

Disclosed herein is an inkjet ink that is suitable for digital inkjet printing on a variety of textile fabrics, including cotton and cotton blends. The inkjet ink disclosed herein includes a pigment, latex binder particles, and a liquid vehicle.

In some examples, the latex binder particles include a single copolymer phase including a first carboxylic acid functional monomer and a first (meth)acrylamide functional monomer, or multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases. As such, it is to be understood that any phase of the multiple copolymer phases may have any of the monomers, as long as both the acid monomer and the acrylamide monomer are present in the latex particles. As examples, the first and/or second phases may include both the carboxylic acid functional monomer and (meth)acrylamide functional monomer, or one of the phases may include the carboxylic acid functional monomer and the other of the phases may include the (meth)acrylamide functional monomer, or one of the phases may include both the carboxylic acid functional monomer and the (meth)acrylamide functional monomer and the other of the phases may include either the carboxylic acid functional monomer or the (meth)acrylamide functional monomer.

In these examples, each of the multiple copolymer phases is non-crosslinked. As used herein, “non-crosslinked” refers to a polymer (or copolymer) that is mostly linear in its chain architecture (allowing for some branching or light crosslinking that can occur during polymerization of acrylates through hydrogen abstraction by active radicals). In other words, the (co)polymer was not produced with multi-vinyl monomers that are used to intentionally induce crosslinking during the main polymerization, nor does it include functional monomers and separate crosslinkers that are used to induce “self-crosslinking” during or after film formation of the latex ink.

In other examples, the latex binder particles consist of a non-crosslinked single copolymer phase including a first carboxylic acid functional monomer and a first (meth)acrylamide functional monomer, or multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases.

The inkjet ink is water-based, and can be formulated for printing via thermal or piezoelectric inkjet printers. It has been found that the inkjet ink, when inkjet printed on the textile fabric, generates prints having a desirable optical density and washfastness, regardless of the textile fabric used. Without being bound to any theory, it is believed that the latex binder particles improve durability because of the combination of the carboxylic acid functional monomer and the (meth)acrylamide functional monomer.

“Washfastness,” as used herein, refers to the ability of a print on a fabric to retain its color after being exposed to washing. Washfastness can be measured in terms of optical density (OD) stability and ΔE. The term “optical density stability,” as referred to herein, means that the degree to which the printed image absorbs incident rays of light remains substantially unchanged after the printed image is washed. To determine the optical density stability of a print, the change in optical density may be measured before and after washing the print, and the percentage of optical density change may be determined. The optical density may be considered to be “substantially unchanged after being washed” when the percentage of optical density change is 10% or less. The term “ΔE,” as used herein, refers to the change in the L*a*b* values of a color (e.g., cyan, magenta, yellow, black, red, green, blue, white) after washing. ΔE can be calculated by different equations, such as the ΔE_{CIE} formula (given in the example section below), the CIEDE1976 color-difference formula, and the CIEDE2000 color-difference formula. ΔE can also be calculated using the color difference method of the Color Measurement Committee (ΔE_{CMC}).

Furthermore, the inkjet ink disclosed herein is jettable. Jettability performance can be measured in terms of decap performance, missing nozzle percentage, drop weight, drop velocity, decel, and Turn-On Energy (TOE) curves.

The term “decap performance,” as referred to herein, means the ability of the inkjet ink to readily eject from any given nozzle after that nozzle has not been actively firing or “serviced” (servicing can include wiping or other means of mechanically clearing nozzle obstructions from the printhead). In these instances, the nozzle(s) may experience prolonged exposure to air. The decap time is measured as the amount of time that nozzles on an uncapped print-head may go without firing or servicing before the printer nozzles no longer fire properly, potentially because of clogging, plugging, or retraction of the colorant from the drop forming region of the nozzle/firing chamber. Good decap performance can lead to good jettability performance, and poor decap performance can lead to poor jettability performance. Further, when an ink has poor decap performance, repeated spitting may be performed to clear the printer nozzles, regain drop jettability, and improve print quality. Such repeated spitting may result in substantial ink waste, which may increase the printing cost.

The term “missing nozzle percentage,” as used herein, refers to the percentage of nozzles that do not fire. Missing nozzle percentage can be measured during other jettability performance testing. For example, missing nozzle percentage may be measured during drop velocity testing. A high missing nozzle percentage can lead to poor jettability performance.

The term “drop weight,” as used herein refers to the weight of the individual drops of ink. Drop weight can be measured by firing a known number of ink drops into a weighing pan that can be used to calculate the theoretical average drop weight. A steady-state drop weight (i.e., calculated by averaging the drop weights measured at a series of low ejection frequencies) and a high frequency drop weight (i.e., measured at a high ejection frequency) can be measured. A drop weight within a set range can lead to good jettability performance. For example, at least 6.0 ng is a desirable drop weight for a magenta ink, but this may depend on the nozzle size that is used. In one example, from about 6.0 ng to about 48.0 ng is a good range for drop weight for a magenta ink from a 12 ng nozzle. In another example, from about 6.0 ng to about 12.0 ng is a good range for drop weight for a magenta ink.

The term “drop velocity,” as used herein refers to the velocity of the individual drops of ink. Drop velocity can be measured by using lasers to track the movement of ink drops as they are jetted through the air from the printhead. A drop velocity within a set range can lead to good jettability performance. For example, from about 10 m/s to about 14 m/s is a good range for drop velocity.

Polymer (latex) particles can interact with other ink components, which, in some instances, can result in ink drop velocity deceleration, or “decel.” The term “decel,” as used herein, refers to the decrease in drop velocity over time (e.g., 6 seconds) of ink droplets fired from an inkjet printhead. In many cases, latex-containing inkjet inks can be subject to decel after the ink has aged for a period of several months. A large decrease in drop velocity (e.g., a decrease in drop velocity of greater than 0.5 m/s) can lead to poor jettability performance, and poor image quality (which can be observed by the color difference between the print samples from continuously firing nozzles and the print samples from non-continuously firing nozzles). In contrast, inks that do not experience decel (i.e., no decrease in drop velocity) or marginal decel (e.g., a decrease in drop velocity of 1 m/s or less) have continuously good jettability performance, and will continue to generate quality printed images.

The term “Turn-On Energy (TOE) curve,” as used herein, refers to the drop weight of an inkjet ink as a function of firing energy. An inkjet ink with good jettability performance also has a good TOE curve, where the ink drop weight rapidly increases (with increased firing energy) to reach a designed drop weight for the pen architecture used; and then a steady drop weight is maintained when the firing energy exceeds the TOE. A desirable TOE curve resembles an upside-down right angle (Γ), and a sharp TOE curve may be correlated with good jettability performance. In contrast, an inkjet ink with a poor TOE curve may show a slow increase in drop weight (with increased firing energy) and/or may never reach the designed drop weight for the pen architecture. A poor TOE curve may be correlated with poor jettability performance.

Throughout this disclosure, a weight percentage that is referred to as “wt % active” refers to the loading of an active component of a dispersion or other formulation that is present in the inkjet ink, the pre-treatment composition, or the overcoat composition. For example, the pigment may be present in a water-based formulation (e.g., a stock solution or dispersion) before being incorporated into the inkjet ink. In this example, the wt % actives of the pigment accounts for the loading (as a weight percent) of the pigment that is present in the inkjet ink, and does not account for the weight of the other components (e.g., water, etc.) that are present in the formulation with the pigment. The term “wt %,” without the term actives, refers to either i) the loading (in the inkjet ink, the pre-treatment composition, or the overcoat composition) of a 100% active component that does not include other non-active components therein, or the loading (in the inkjet ink, the pre-treatment composition, or the overcoat composition) of a material or component that is used “as is” and thus the wt % accounts for both active and non-active components.

Inkjet Inks

Examples of the inkjet ink disclosed herein will now be described. As mentioned above, the inkjet ink, when inkjet printed on the textile fabric, generates prints having a desirable optical density and washfastness. As also mentioned above, the inkjet ink is stable and jettable.

In some examples, the inkjet ink for textile printing comprises: a pigment; latex binder particles including: a single copolymer phase including a first carboxylic acid functional monomer and a first (meth)acrylamide functional monomer; or multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases; and a liquid vehicle. In some of these examples, the inkjet ink consists of these components with no other components. In these examples, the inkjet ink consists of the pigment, the latex binder particles, and the liquid vehicle. In one of these examples, the liquid vehicle consists of water and a co-solvent. In other examples, the inkjet ink may include additional components.

In other examples, the inkjet ink for textile printing comprises: a pigment; latex binder particles consisting of: a non-crosslinked single copolymer phase including a first carboxylic acid functional monomer and a first (meth)acrylamide functional monomer; multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases; or a liquid vehicle. In some of these examples, the inkjet ink consists of these components with no other components. In these examples, the inkjet ink consists of the pigment, the latex binder particles, and the liquid vehicle. In one of these examples, the liquid vehicle consists of water and a co-solvent. In other examples, the inkjet ink may include additional components.

Examples of the inkjet ink disclosed herein may be used in a thermal inkjet printer or in a piezoelectric printer to print on a (pre-treated) textile fabric. The viscosity of the inkjet ink may be adjusted for the type of printhead that is to be used, and the viscosity may be adjusted by adjusting the co-solvent level, adjusting the latex binder particles level, and/or adding a viscosity modifier. When used in a thermal inkjet printer, the viscosity of the inkjet ink may be modified to range from about 1 cP to about 9 cP (at 20° C. to 25° C.), and when used in a piezoelectric printer, the viscosity of the inkjet ink may be modified to range from about 2 cP to about 20 cP (at 20° C. to 25° C.), depending on the type of the printhead that is being used (e.g., low viscosity printheads, medium viscosity printheads, or high viscosity printheads).

Pigments

The pigment may be incorporated into the inkjet ink as a pigment dispersion. The pigment dispersion may include a pigment and a separate dispersant, or may include a self-dispersed pigment.

For the pigment dispersions disclosed herein, it is to be understood that the pigment and separate dispersant or the self-dispersed pigment (prior to being incorporated into the ink formulation), may be dispersed in water alone or in combination with an additional water soluble or water miscible co-solvent, such as 2-pyrrolidone, 1-(2-hydroxyethyl)-2-pyrrolidone, glycerol, 2-methyl-1,3-propanediol, 1,2-butane diol, diethylene glycol, triethylene glycol, tetraethylene glycol, or a combination thereof. It is to be understood however, that the liquid components of the pigment dispersion become part of the liquid vehicle in the inkjet ink.

Whether separately dispersed or self-dispersed, the pigment can be any of a number of primary or secondary colors, or black or white. As specific examples, the pigment may be any color, including, as examples, a cyan pigment, a magenta pigment, a yellow pigment, a black pigment, a violet pigment, a green pigment, a brown pigment, an orange pigment, a purple pigment, a white pigment, or combinations thereof.

Pigments and Separate Dispersants

Examples of the inkjet ink may include a pigment that is not self-dispersing and a separate dispersant. Examples of these pigments, as well as suitable dispersants for these pigments will now be described.

Examples of suitable blue or cyan organic pigments include C.I. Pigment Blue 1, C.I. Pigment Blue 2, C.I. Pigment Blue 3, C.I. Pigment Blue 15, Pigment Blue 15:3, C.I. Pigment Blue 15:4, C.I. Pigment Blue 16, C.I. Pigment Blue 18, C.I. Pigment Blue 22, C.I. Pigment Blue 25, C.I. Pigment Blue 60, C.I. Pigment Blue 65, C.I. Pigment Blue 66, C.I. Vat Blue 4, and C.I. Vat Blue 60.

Examples of suitable magenta, red, or violet organic pigments include C.I. Pigment Red 1, C.I. Pigment Red 2, C.I. Pigment Red 3, C.I. Pigment Red 4, C.I. Pigment Red 5, C.I. Pigment Red 6, C.I. Pigment Red 7, C.I. Pigment Red 8, C.I. Pigment Red 9, C.I. Pigment Red 10, C.I. Pigment Red 11, C.I. Pigment Red 12, C.I. Pigment Red 14, C.I. Pigment Red 15, C.I. Pigment Red 16, C.I. Pigment Red 17, C.I. Pigment Red 18, C.I. Pigment Red 19, C.I. Pigment Red 21, C.I. Pigment Red 22, C.I. Pigment Red 23, C.I. Pigment Red 30, C.I. Pigment Red 31, C.I. Pigment Red 32, C.I. Pigment Red 37, C.I. Pigment Red 38, C.I. Pigment Red 40, C.I. Pigment Red 41, C.I. Pigment Red 42, C.I. Pigment Red 48(Ca), C.I. Pigment Red 48(Mn), C.I. Pigment Red 57(Ca), C.I. Pigment Red 57:1, C.I. Pigment Red 88, C.I. Pigment Red 112, C.I. Pigment Red 114, C.I. Pigment Red 122, C.I. Pigment Red 123, C.I. Pigment Red 144, C.I. Pigment Red 146, C.I. Pigment Red 149, C.I. Pigment Red 150, C.I. Pigment Red 166, C.I. Pigment Red 168, C.I. Pigment Red 170, C.I. Pigment Red 171, C.I. Pigment Red 175, C.I. Pigment Red 176, C.I. Pigment Red 177, C.I. Pigment Red 178, C.I. Pigment Red 179, C.I. Pigment Red 184, C.I. Pigment Red 185, C.I. Pigment Red 187, C.I. Pigment Red 202, C.I. Pigment Red 209, C.I. Pigment Red 219, C.I. Pigment Red 224, C.I. Pigment Red 245, C.I. Pigment Red 286, C.I. Pigment Violet 19, C.I. Pigment Violet 23, C.I. Pigment Violet 32, C.I. Pigment Violet 33, C.I. Pigment Violet 36, C.I. Pigment Violet 38, C.I. Pigment Violet 43, and C.I. Pigment Violet 50. Any quinacridone pigment or a co-crystal of quinacridone pigments may be used for magenta inks.

Examples of suitable yellow organic pigments include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 7, C.I. Pigment Yellow 10, C.I. Pigment Yellow 11, C.I. Pigment Yellow 12, C.I. Pigment Yellow 13, C.I. Pigment Yellow 14, C.I. Pigment Yellow 16, C.I. Pigment Yellow 17, C.I. Pigment Yellow 24, C.I. Pigment Yellow 34, C.I. Pigment Yellow 35, C.I. Pigment Yellow 37, C.I. Pigment Yellow 53, C.I. Pigment Yellow 55, C.I. Pigment Yellow 65, C.I. Pigment Yellow 73, C.I. Pigment Yellow 74, C.I. Pigment Yellow 75, C.I. Pigment Yellow 77, C.I. Pigment Yellow 81, C.I. Pigment Yellow 83, C.I. Pigment Yellow 93, C.I. Pigment Yellow 94, C.I. Pigment Yellow 95, C.I. Pigment Yellow 97, C.I. Pigment Yellow 98, C.I. Pigment Yellow 99, C.I. Pigment Yellow 108, C.I. Pigment Yellow 109, C.I. Pigment Yellow 110, C.I. Pigment Yellow 113, C.I. Pigment Yellow 114, C.I. Pigment Yellow 117, C.I. Pigment Yellow 120, C.I. Pigment Yellow 122, C.I. Pigment Yellow 124, C.I. Pigment Yellow 128, C.I. Pigment Yellow 129, C.I. Pigment Yellow 133, C.I. Pigment Yellow 138, C.I. Pigment Yellow 139, C.I. Pigment Yellow 147, C.I. Pigment Yellow 151, C.I. Pigment Yellow 153, C.I. Pigment Yellow 154, C.I. Pigment Yellow 155, C.I. Pigment Yellow 167, C.I. Pigment Yellow 172, C.I. Pigment Yellow 180, C.I. Pigment Yellow 185, and C.I. Pigment Yellow 213.

Carbon black may be a suitable inorganic black pigment. Examples of carbon black pigments include those manufactured by Mitsubishi Chemical Corporation, Japan (such as, e.g., carbon black No. 2300, No. 900, MCF88, No. 33, No. 40, No. 45, No. 52, MA7, MA8, MA100, and No. 2200B); various carbon black pigments of the RAVEN® series manufactured by Columbian Chemicals Company, Marietta, Ga., (such as, e.g., RAVEN® 5750, RAVEN® 5250, RAVEN® 5000, RAVEN® 3500, RAVEN® 1255, and RAVEN® 700); various carbon black pigments of the REGAL® series, BLACK PEARLS® series, the MOGUL® series, or the MONARCH® series manufactured by Cabot Corporation, Boston, Mass., (such as, e.g., REGAL® 400R, REGAL® 330R, REGAL® 660R, BLACK PEARLS® 700, BLACK PEARLS® 800, BLACK PEARLS® 880, BLACK PEARLS® 1100, BLACK PEARLS® 4350, BLACK PEARLS® 4750, MOGUL® E, MOGUL® L, and ELFTEX® 410); and various black pigments manufactured by Evonik Degussa Orion Corporation, Parsippany, N.J., (such as, e.g., Color Black FW1, Color Black FW2, Color Black FW2V, Color Black FW18, Color Black FW200, Color Black S150, Color Black S160, Color Black S170, PRINTEX® 35, PRINTEX® 75, PRINTEX® 80, PRINTEX® 85, PRINTEX® 90, PRINTEX® U, PRINTEX® V, PRINTEX® 140U, Special Black 5, Special Black 4A, and Special Black 4). An example of an organic black pigment includes aniline black, such as C.I. Pigment Black 1.

Some examples of green organic pigments include C.I. Pigment Green 1, C.I. Pigment Green 2, C.I. Pigment Green 4, C.I. Pigment Green 7, C.I. Pigment Green 8, C.I. Pigment Green 10, C.I. Pigment Green 36, and C.I. Pigment Green 45.

Examples of brown organic pigments include C.I. Pigment Brown 1, C.I. Pigment Brown 5, C.I. Pigment Brown 22, C.I. Pigment Brown 23, C.I. Pigment Brown 25, C.I. Pigment Brown 41, and C.I. Pigment Brown 42.

Some examples of orange organic pigments include C.I. Pigment Orange 1, C.I. Pigment Orange 2, C.I. Pigment Orange 5, C.I. Pigment Orange 7, C.I. Pigment Orange 13, C.I. Pigment Orange 15, C.I. Pigment Orange 16, C.I. Pigment Orange 17, C.I. Pigment Orange 19, C.I. Pigment Orange 24, C.I. Pigment Orange 34, C.I. Pigment Orange 36, C.I. Pigment Orange 38, C.I. Pigment Orange 40, C.I. Pigment Orange 43, C.I. Pigment Orange 64, C.I. Pigment Orange 66, C.I. Pigment Orange 71, and C.I. Pigment Orange 73.

The average particle size of the pigments may range anywhere from about 20 nm to about 200 nm. In an example, the average particle size ranges from about 80 nm to about 150 nm.

Any of the pigments mentioned herein can be dispersed by a separate dispersant, such as a styrene (meth)acrylate dispersant, or another dispersant suitable for keeping the pigment suspended in the liquid vehicle. For example, the dispersant can be any dispersing (meth)acrylate polymer, or other type of polymer, such as maleic polymer or a dispersant with aromatic groups and a poly(ethylene oxide) chain.

In one example, (meth)acrylate polymer can be a styrene-acrylic type dispersant polymer, as it can promote Tr-stacking between the aromatic ring of the dispersant and various types of pigments, such as copper phthalocyanine pigments, for example. In this example, the inkjet ink further comprises a styrene acrylic polymeric dispersant. In one example, the styrene-acrylic dispersant can have a weight average molecular weight (M_{w}) ranging from about 2,000 to about 30,000. In another example, the styrene-acrylic dispersant can have a weight average molecular weight ranging from about 8,000 to about 28,000, from about 12,000 to about 25,000, from about 15,000 to about 25,000, from about 15,000 to about 20,000, or about 17,000. Regarding the acid number, the styrene-acrylic dispersant can have an acid number from 100 to 350, from 120 to 350, from 150 to 250, from 155 to 185, or about 172, for example. Example commercially available styrene-acrylic dispersants can include JONCRYL® 671, JONCRYL® 71, JONCRYL® 96, JONCRYL® 680, JONCRYL® 683, JONCRYL® 678, JONCRYL® 690, JONCRYL® 296, JONCRYL® 696 or JONCRYL® ECO 675 (all available from BASF Corp.).

The term “(meth)acrylate” or “(meth)acrylic acid” or the like refers to monomers, copolymerized monomers, etc., that can either be acrylate or methacrylate (or a combination of both), or acrylic acid or methacrylic acid (or a combination of both). Also, in some examples, the terms “(meth)acrylate” and “(meth)acrylic acid” can be used interchangeably, as acrylates and methacrylates are salts and esters of acrylic acid and methacrylic acid, respectively. Furthermore, mention of one compound over another can be a function of pH. For examples, even if the monomer used to form the polymer was in the form of a (meth)acrylic acid during preparation, pH modifications during preparation or subsequently when added to an inkjet ink can impact the nature of the moiety as well (acid form vs. salt or ester form). Thus, a monomer or a moiety of a polymer described as (meth)acrylic acid or as (meth)acrylate should not be read so rigidly as to not consider relative pH levels, ester chemistry, and other general organic chemistry concepts.

The following are some example pigment and separate dispersant combinations: a carbon black pigment with a styrene acrylic dispersant; PB 15:3 (cyan pigment) with a styrene acrylic dispersant; PR122 (magenta) or a co-crystal of PR122 and PV19 (magenta) with a styrene acrylic dispersant; or PY74 (yellow) or PY155 (yellow) with a styrene acrylic dispersant.

In an example, the pigment is present in an amount ranging from about 1 wt % active to about 10 wt % active, based on a total weight of the inkjet ink. In another example, the pigment is present in the inkjet ink in an amount ranging from about 1 wt % active to about 6 wt % active of the total weight of the inkjet ink. In still another example, the pigment is present in the inkjet ink in an amount ranging from about 2 wt % active to about 6 wt % active of the total weight of the inkjet ink. When the separate dispersant is used, the separate dispersant may be present in an amount ranging from about 0.05 wt % active to about 6 wt % active of the total weight of the inkjet ink. In some examples, the ratio of pigment to separate dispersant may range from 0.5 (1:2) to 10 (10:1).

Self-Dispersed Pigments

In other examples, the inkjet ink includes a self-dispersed pigment, which includes a pigment and an organic group attached thereto.

Any of the pigments set forth herein may be used, such as carbon, phthalocyanine, quinacridone, azo, or any other type of organic pigment, as long as at least one organic group that is capable of dispersing the pigment is attached to the pigment.

The organic group that is attached to the pigment includes at least one aromatic group, an alkyl (e.g., C₁ to C₂₀), and an ionic or ionizable group.

The aromatic group may be an unsaturated cyclic hydrocarbon containing one or more rings and may be substituted or unsubstituted, for example with alkyl groups. Aromatic groups include aryl groups (for example, phenyl, naphthyl, anthracenyl, and the like) and heteroaryl groups (for example, imidazolyl, pyrazolyl, pyridinyl, thienyl, thiazolyl, furyl, triazinyl, indolyl, and the like).

The alkyl may be branched or unbranched, substituted or unsubstituted.

The ionic or ionizable group may be at least one phosphorus-containing group, at least one sulfur-containing group, or at least one carboxylic acid group.

In an example, the at least one phosphorus-containing group has at least one P—O bond or P═O bond, such as at least one phosphonic acid group, at least one phosphinic acid group, at least one phosphinous acid group, at least one phosphite group, at least one phosphate, diphosphate, triphosphate, or pyrophosphate groups, partial esters thereof, or salts thereof. By “partial ester thereof”, it is meant that the phosphorus-containing group may be a partial phosphonic acid ester group having the formula —PO₃RH, or a salt thereof, wherein R is an aryl, alkaryl, aralkyl, or alkyl group. By “salts thereof”, it is meant that the phosphorus-containing group may be in a partially or fully ionized form having a cationic counterion.

When the organic group includes at least two phosphonic acid groups or salts thereof, either or both of the phosphonic acid groups may be a partial phosphonic ester group. Also, one of the phosphonic acid groups may be a phosphonic acid ester having the formula —PO₃R₂, while the other phosphonic acid group may be a partial phosphonic ester group, a phosphonic acid group, or a salt thereof. In some instances, it may be desirable that at least one of the phosphonic acid groups is either a phosphonic acid, a partial ester thereof, or salts thereof. When the organic group includes at least two phosphonic acid groups, either or both of the phosphonic acid groups may be in either a partially or fully ionized form. In these examples, either or both may of the phosphonic acid groups have the formula —PO₃H₂, —PO₃H⁻M⁺ (monobasic salt), or —PO₃² M⁺² (dibasic salt), wherein M⁺ is a cation such as Na⁺, K⁺, Li⁺, or NR₄⁺, wherein R, which can be the same or different, represents hydrogen or an organic group such as a substituted or unsubstituted aryl and/or alkyl group.

As other examples, the organic group may include at least one geminal bisphosphonic acid group, partial esters thereof, or salts thereof. By “geminal”, it is meant that the at least two phosphonic acid groups, partial esters thereof, or salts thereof are directly bonded to the same carbon atom. Such a group may also be referred to as a 1,1-diphosphonic acid group, partial ester thereof, or salt thereof.

An example of a geminal bisphosphonic acid group may have the formula —CQ(PO₃H₂)₂, or may be partial esters thereof or salts thereof. Q is bonded to the geminal position and may be H, R, OR, SR, or NR₂ wherein R, which can be the same or different when multiple are present, is selected from H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. For examples, Q may be H, R, OR, SR, or NR₂, wherein R, which can be the same or different when multiple are present, is selected from H, a C₁-C₆ alkyl group, or an aryl group. As specific examples, Q is H, OH, or NH₂. Another example of a geminal bisphosphonic acid group may have the formula —(CH₂),CQ(PO₃H₂)₂, or may be partial esters thereof or salts thereof, wherein Q is as described above and n is 0 to 9, such as 1 to 9. In some specific examples, n is 0 to 3, such as 1 to 3, or n is either 0 or 1.

Still another example of a geminal bisphosphonic acid group may have the formula —X—(CH₂)ₙCQ(PO₃H₂)₂, or may be partial esters thereof or salts thereof, wherein Q and n are as described above and X is an arylene, heteroarylene, alkylene, vinylidene, alkarylene, aralkylene, cyclic, or heterocyclic group. In specific examples, X is an arylene group, such as a phenylene, naphthalene, or biphenylene group, which may be further substituted with any group, such as one or more alkyl groups or aryl groups. When X is an alkylene group, examples include substituted or unsubstituted alkylene groups, which may be branched or unbranched and can be substituted with one or more groups, such as aromatic groups. Examples of X include C₁-C₁₂ groups like methylene, ethylene, propylene, or butylene. X may be directly attached to the pigment, meaning there are no additional atoms or groups from the attached organic group between the pigment and X. X may also be further substituted with one or more functional groups. Examples of functional groups include R′, OR′, COR′, COOR′, OCOR′, carboxylates, halogens, CN, NR′₂, SO₃H, sulfonates, sulfates, NR′(COR′), CONR′₂, imides, NO₂, phosphates, phosphonates, N═NR′, SOR′, NR′SO₂R′, and SO₂NR′₂, wherein R′, which can be the same or different when multiple are present, is independently selected from hydrogen, branched or unbranched C₁-C₂₀ substituted or unsubstituted, saturated or unsaturated hydrocarbons, e.g., alkyl, alkenyl, alkynyl, substituted or unsubstituted aryl, substituted or unsubstituted heteroaryl, substituted or unsubstituted alkaryl, or substituted or unsubstituted aralkyl.

Yet another example of a geminal bisphosphonic acid group may have the formula —X-Sp-(CH₂)ₙCQ(PO₃H₂)₂, or may be partial esters thereof or salt thereof, wherein X, Q, and n are as described above. “Sp” is a spacer group, which, as used herein, is a link between two groups. Sp can be a bond or a chemical group. Examples of chemical groups include, but are not limited to, —CO₂—, —O₂C—, —CO—, —OSO₂—, —SO₃—, —SO₂—, —SO₂C₂H₄O—, —SO₂C₂H₄S—, —SO₂C₂H₄NR″—, —O—, —S—, —NR″—, —NR″CO—, —CONR″—, —NR″CO₂—, —O₂CNR″—, —NR″CONR″—, —N(COR″)CO—, —CON(COR″)—, —NR″COCH(CH₂CO₂R″)— and cyclic imides therefrom, —NR″COCH₂CH(CO₂R″)— and cyclic imides therefrom, —CH(CH₂CO₂R″)CONR″— and cyclic imides therefrom, —CH(CO₂R″)CH₂CONR″ and cyclic imides therefrom (including phthalimide and maleimides of these), sulfonamide groups (including —SO₂NR″— and —NR″SO₂— groups), arylene groups, alkylene groups and the like. R″, which can be the same or different when multiple are included, represents H or an organic group such as a substituted or unsubstituted aryl or alkyl group. In the example formula —X-Sp-(CH₂),CQ(PO₃H₂)₂, the two phosphonic acid groups or partial esters or salts thereof are bonded to X through the spacer group Sp. Sp may be —CO₂—, —O₂C—, —O—, —NR″—, —NR″CO—, or —CONR″—, —SO₂NR″—, —SO₂CH₂CH₂NR″—, —SO₂CH₂CH₂O—, or —SO₂CH₂CH₂S— wherein R″ is H or a C₁-C₆ alkyl group.

Still a further example of a geminal bisphosphonic acid group may have the formula —N—[(CH₂)ₘ(PO₃H₂)]₂, partial esters thereof, or salts thereof, wherein m, which can be the same or different, is 1 to 9. In specific examples, m is 1 to 3, or 1 or 2. As another example, the organic group may include at least one group having the formula —(CH₂)ₙ—N—[(CH₂)ₘ(PO₃H₂)]₂, partial esters thereof, or salts thereof, wherein n is 0 to 9, such as 1 to 9, or 0 to 3, such as 1 to 3, and m is as defined above. Also, the organic group may include at least one group having the formula —X—(CH₂)ₙ—N—[(CH₂)ₘ(PO₃H₂)]₂, partial esters thereof, or salts thereof, wherein X, m, and n are as described above, and, in an example, X is an arylene group. Still further, the organic group may include at least one group having the formula —X-Sp-(CH₂)ₙ—N—[(CH₂)ₘ(PO₃H₂)]₂, partial esters thereof, or salts thereof, wherein X, m, n, and Sp are as described above.

Yet a further example of a geminal bisphosphonic acid group may have the formula —CR═C(PO₃H₂)₂, partial esters thereof, or salts thereof. In this example, R can be H, a C₁-C₁₈ saturated or unsaturated, branched or unbranched alkyl group, a C₁-C₁₈ saturated or unsaturated, branched or unbranched acyl group, an aralkyl group, an alkaryl group, or an aryl group. In an example, R is H, a C₁-C₆ alkyl group, or an aryl group.

The organic group may also include more than two phosphonic acid groups, partial esters thereof, or salts thereof, and may, for example include more than one type of group (such as two or more) in which each type of group includes at least two phosphonic acid groups, partial esters thereof, or salts thereof. For example, the organic group may include a group having the formula —X—[CQ(PO₃H₂)₂]ₚ, partial esters thereof, or salts thereof. In this example, X and Q are as described above. In this formula, p is 1 to 4, e.g., 2.

In addition, the organic group may include at least one vicinal bisphosphonic acid group, partial ester thereof, or salts thereof, meaning that these groups are adjacent to each other. Thus, the organic group may include two phosphonic acid groups, partial esters thereof, or salts thereof bonded to adjacent or neighboring carbon atoms. Such groups are also sometimes referred to as 1,2-diphosphonic acid groups, partial esters thereof, or salts thereof. The organic group including the two phosphonic acid groups, partial esters thereof, or salts thereof may be an aromatic group or an alkyl group, and therefore the vicinal bisphosphonic acid group may be a vicinal alkyl or a vicinal aryl diphosphonic acid group, partial ester thereof, or salts thereof. For example, the organic group may be a group having the formula —C₆H₃—(PO₃H₂)₂, partial esters thereof, or salts thereof, wherein the acid, ester, or salt groups are in positions ortho to each other.

In other examples, the ionic or ionizable group (of the organic group attached to the pigment) is a sulfur-containing group. The at least one sulfur-containing group has at least one S═O bond, such as a sulfinic acid group or a sulfonic acid group. Salts of sulfinic or sulfonic acids may also be used, such as —SO₃⁻X⁺, where X is a cation, such as Na⁺, H⁺, K⁺, NH₄⁺, Li⁺, Ca²⁺, Mg⁺, etc.

When the ionic or ionizable group is a carboxylic acid group, the group may be COOH or a salt thereof, such as —COO⁻X⁺, —(COO⁻X⁺)₂, or —(COO⁻X⁺)₃.

Examples of the self-dispersed pigments are commercially available as dispersions. Suitable commercially available self-dispersed pigment dispersions include those of the CAB-O-JET® 200 Series, manufactured by Cabot Corporation. Some specific examples include CAB-O-JET® 200 (black pigment), CAB-O-JET® 250C (cyan pigment), CAB-O-JET® 260M or 265M (magenta pigment) and CAB-O-JET® 270 (yellow pigment)). Other suitable commercially available self-dispersed pigment dispersions include those of the CAB-O-JET® 400 Series, manufactured by Cabot Corporation. Some specific examples include CAB-O-JET® 400 (black pigment), CAB-O-JET® 450C (cyan pigment), CAB-O-JET® 465M (magenta pigment) and CAB-O-JET® 470Y (yellow pigment)). Still other suitable commercially available self-dispersed pigment dispersions include those of the CAB-O-JET® 300 Series, manufactured by Cabot Corporation. Some specific examples include CAB-O-JET® 300 (black pigment) and CAB-O-JET® 352K (black pigment).

The self-dispersed pigment may be present in an amount ranging from about 1 wt % active to about 10 wt % active based on a total weight of the inkjet ink. In an example, the self-dispersed pigment is present in an amount ranging from about 1 wt % active to about 6 wt % active based on a total weight of the inkjet ink. In another example, the self-dispersed pigment is present in an amount ranging from about 2 wt % active to about 5 wt % active based on a total weight of the inkjet ink. In yet another example, the self-dispersed pigment is present in an amount of about 3 wt % based on the total weight of the inkjet ink. In still another example, the self-dispersed pigment is present in an amount of about 5 wt % active based on the total weight of the inkjet ink.

Latex Binder Particles

The inkjet ink also includes the latex binder particles. As used herein, the term “latex” refers to polymer (or copolymer) particles in an aqueous dispersion. In an example, the copolymer particles may be incorporated into the ink as part of the aqueous dispersion. As mentioned above, the latex binder particles improve the durability of inkjet ink.

The latex binder particles include a combination of a carboxylic acid functional monomer and a (meth)acrylamide functional monomer. The latex binder particles may include a single copolymer phase including a first carboxylic acid functional monomer and a first (meth)acrylamide functional monomer, or multiple copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases. In any of the examples disclosed herein, the inkjet ink may include a combination of different types of latex binder particles. For example, the inkjet ink may include a combination of the latex binder particles including (or consisting of) the single copolymer phase and of the latex binder particles including (or consisting of) the multiple non-crosslinked copolymer phases.

It is to be understood that the designations “first”, “second”, etc., as applied herein to carboxylic acid functional monomers and (meth)acrylamide functional monomers, do not designate a particular order, but rather are added as identifiers in order to clearly refer to particular monomers.

Further, in examples disclosed herein, a particular monomer may be described as constituting a certain weight percentage of the single copolymer phase or of a phase (e.g., the first or second copolymer phase) of the multiple copolymer phases. This indicates that the repeating units formed from the identified monomer make up the given percentage (w/w) of the single copolymer phase or the particular phase of the multiple copolymer phases.

The carboxylic acid functional monomer may be selected from the group consisting of acrylic acid, methacrylic acid, 2-carboxyethyl acrylate, 3-(methacryloyloxy)propionic acid, itaconic acid, citraconic acid, fumaric acid, crotonic acid, maleic acid, and a combination thereof. In some examples, the first carboxylic acid functional monomer (of the single copolymer phase) is selected from the group consisting of acrylic acid, methacrylic acid, 2-carboxyethyl acrylate, 3-(methacryloyloxy)propionic acid, itaconic acid, citraconic acid, fumaric acid, crotonic acid, maleic acid, and a combination thereof; or the second carboxylic acid functional monomer (of one of the copolymer phases of the multiple copolymer phases) is selected from the group consisting of acrylic acid, methacrylic acid, 2-carboxyethyl acrylate, 3-(methacryloyloxy)propionic acid, itaconic acid, citraconic acid, fumaric acid, crotonic acid, maleic acid, and a combination thereof.

As used herein, the notation “(meth)acrylamide” includes both acrylamide and methacrylamide variations. (Meth)acrylamide functional monomer may be selected from the group consisting of acrylamide, methacrylamide, n-methylolacrylamide, n-methylolmethacrylamide, a hydroxyalkyl acrylamide, 3-methoxypropyl acrylamide, n-butoxymethyl acrylamide, isobutoxymethyl acrylamide, diacetone acrylamide, and a combination thereof. In some examples, the first (meth)acrylamide functional monomer is selected from the group consisting of acrylamide, methacrylamide, n-methylolacrylamide, n-methylolmethacrylamide, a hydroxyalkyl acrylamide, 3-methoxypropyl acrylamide, n-butoxymethyl acrylamide, isobutoxymethyl acrylamide, diacetone acrylamide, and a combination thereof; or the second (meth)acrylamide functional monomer is selected from the group consisting of acrylamide, methacrylamide, n-methylolacrylamide, n-methylolmethacrylamide, a hydroxyalkyl acrylamide, 3-methoxypropyl acrylamide, n-butoxymethyl acrylamide, isobutoxymethyl acrylamide, diacetone acrylamide, and a combination thereof.

In some examples, any of the first or second carboxylic acid functional monomers are independently selected from the group consisting of acrylic acid, methacrylic acid, 2-carboxyethyl acrylate, 3-(methacryloyloxy)propionic acid, itaconic acid, citraconic acid, fumaric acid, crotonic acid, maleic acid, and a combination thereof; and any of the first or second (meth)acrylamide functional monomers are independently selected from the group consisting of acrylamide, methacrylamide, n-methylolacrylamide, n-methylolmethacrylamide, a hydroxyalkyl acrylamide, 3-methoxypropyl acrylamide, n-butoxymethyl acrylamide, isobutoxymethyl acrylamide, diacetone acrylamide, and a combination thereof.

In some examples, the latex binder particles consist of the single copolymer phase, or the multiple non-crosslinked copolymer phases. By “single copolymer phase”, is it meant that a latex binder particle contains a single copolymer, which is present as a single phase. By “multiple non-crosslinked copolymer phases”, it is meant that the latex binder particle contains multiple non-crosslinked copolymers, which are present as multiple phases within the particle. With multiple phases, the copolymers have phase separated from each other to be present as distinctly different domains within the same latex particle. In other examples, the latex binder particles may include additional components.

In some examples, the latex binder particles include the single copolymer phase of the first carboxylic acid functional monomer and the first (meth)acrylamide functional monomer. In some of these examples, the latex binder particles consist of the single copolymer phase with no other components.

In some examples, the single copolymer phase consists of the first carboxylic acid functional monomer, the first (meth)acrylamide functional monomer, and an ethylenically unsaturated monomer, with no other components. In one of these examples, the latex binder particles consist of the single copolymer phase, and the single copolymer phase consists of the first carboxylic acid functional monomer, the first (meth)acrylamide functional monomer, and the ethylenically unsaturated monomer. As an example, the single copolymer phase may include up to about 15 wt % of the first carboxylic acid functional monomer, up to about 15 wt % of the first (meth)acrylamide functional monomer, and at least 70 wt % of the ethylenically unsaturated monomer. The ethylenically unsaturated monomer may be one type of ethylenically unsaturated monomer or a mixture of different types of ethylenically unsaturated monomers. In still other example, the single copolymer phase includes the listed monomers, as well as a copolymerizable surfactant.

Examples of the ethylenically unsaturated monomer(s) include acrylic monomers or styrenic monomers. In some examples, the acrylic monomers are acrylates and/or methacrylates and the styrenic monomers are styrene or derivatives of styrene.

As used herein, the notation “(meth)acrylates” includes both acrylate and methacrylate variations. These include mono(meth)acrylates, di(meth)acrylates, or polyfunctional alkoxylated or polyalkoxylated (meth)acrylic monomers comprising one or more di- or tri-(meth)acrylates. Suitable mono(meth)acrylates include, for example, methyl (meth)acrylate, ethyl (meth)acrylate, propyl (meth)acrylate, n-butyl (meth)acrylate, iso-butyl (meth)acrylate, cyclohexyl (meth)acrylate, 2-ethoxy ethyl (meth)acrylate, 2-methoxy ethyl (meth)acrylate, 2(2-ethoxyethoxy)ethyl (meth)acrylate, stearyl (meth)acrylate, tetrahydrofurfuryl (meth)acrylate, octyl (meth)acrylate, lauryl (meth)acrylate, behenyl (meth)acrylate, 2-phenoxy ethyl (meth)acrylate, tertiary butyl (meth)acrylate, glycidyl (meth)acrylate, isodecyl (meth)acrylate, benzyl (meth)acrylate, hexyl (meth)acrylate, isooctyl (meth)acrylate, isobornyl (meth)acrylate, butanediol mono(meth)acrylate, ethoxylated phenol mono(meth)acrylate, oxyethylated phenol (meth)acrylate, monomethoxy hexanediol (meth)acrylate, beta-carboxy ethyl (meth)acrylate, dicyclopentyl (meth)acrylate, carbonyl (meth)acrylate, octyl decyl (meth)acrylate, ethoxylated nonylphenol (meth)acrylate, hydroxyethyl (meth)acrylate, hydroxypropyl (meth)acrylate, and the like. Suitable polyfunctional alkoxylated or polyalkoxylated (meth)acrylates include, for example, alkoxylated, such as, ethoxylated, or propoxylated, variants of the following: neopentyl glycol di(meth)acrylates, butanediol di(meth)acrylates, trimethylolpropane tri(meth)acrylates, glyceryl tri(meth)acrylates, 1,3-butylene glycol di(meth)acrylate, 1,4-butanediol di(meth)acrylate, diethylene glycol di(meth)acrylate, 1,6-hexanediol di(meth)acrylate, tetraethylene glycol di(meth)acrylate, triethylene glycol di(meth)acrylate, tripropylene glycol di(meth)acrylate, polybutanediol di(meth)acrylate, polyethylene glycol di(meth)acrylate, propoxylated neopentyl glycol di(meth)acrylate, ethoxylated neopentyl glycol di(meth)acrylate, polybutadiene di(meth)acrylate, and the like.

Examples of styrenic monomers include styrene and methylstyrenes, such as α-methyl styrene and p-methyl styrene.

In one example, the ethylenically unsaturated monomers include a mixture of methyl methacrylate, n-butyl acrylate, n-butyl methacrylate, 2-ethylhexyl acrylate and/or styrene.

The single copolymer phase may include a combined total of up to 30 wt % of the first carboxylic acid functional monomer and the first (meth)acrylamide functional monomer, based on the total weight of the single copolymer phase. In other examples, the single copolymer phase may include a combined total of up to 20 wt % or up to 10 wt % of the first carboxylic acid functional monomer and the first (meth)acrylamide functional monomer, based on the total weight of the single copolymer phase. In one example, the latex binder particles include the single copolymer phase, and the single copolymer phase includes up to 30 wt % of the first carboxylic acid functional monomer and the first (meth)acrylamide functional monomer, based on a total weight of the single copolymer phase, and at least 70 wt % of other ethylenically unsaturated monomer(s), based on the total weight of the single copolymer phase.

In each of these examples, the single copolymer phase may include about the same amount of the first carboxylic acid functional monomer and the first (meth)acrylamide functional monomer. In some examples, the single copolymer phase may include about 5 wt %, about 10 wt %, or about 15 wt % of the first carboxylic acid functional monomer, and the single copolymer phase may include about 5 wt %, about 10 wt %, or about 15 wt % of the first(meth)acrylamide functional monomer, based on the total weight of the single copolymer phase.

In each of these examples, the additional ethylenically unsaturated monomer(s) (alone or in combination with the copolymerizable surfactant) may make up the remaining amount of the single copolymer phase. In some examples, the single copolymer phase may include at least 70 wt % of the additional monomer(s), based on the total weight of the single copolymer phase. In other examples, the single copolymer phase may include at least 80 wt % or at least 90 wt % of the additional monomer(s), based on the total weight of the single copolymer phase.

In some examples, the latex binder particles include the multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases. It is to be understood that the designations “first”, “second”, etc., as applied herein to the copolymer phases, do not designate a particular order, but rather are added as identifiers in order to clearly refer to particular phases. As such, while the first copolymer phase may be described herein as including the second carboxylic acid functional monomer and the second copolymer phase may be described herein as including the second (meth)acrylamide functional monomer, the first copolymer phase may be as the second copolymer phase is described and/or the second copolymer phase may be as the first copolymer phase is described.

In some examples, the multiple copolymer phases consist of the first copolymer phase and the second copolymer phase, with no other components. In other examples, the multiple copolymer phases include additional phases (e.g., a third copolymer phase, a fourth copolymer phase, etc.).

In some examples, the latex binder particles include of the multiple copolymer phases, having from about 10 wt % to about 90 wt % of the first copolymer phase and from about 10 wt % to about 90 wt % of the second copolymer phase. As a specific example, the multi-phase version of the latex binder particles may have about 85 wt % the first copolymer phase and about 15 wt % of the second copolymer phase.

When included, the additional copolymer phase(s) (e.g., third, fourth, etc.) may be included in the multi-phase latex in an amount ranging from about 10 wt % to about 90 wt %, based on the total weight of the multiple copolymer phases.

In some examples, the first copolymer phase consists of the second carboxylic acid functional monomer and an ethylenically unsaturated monomer, with no other components.

In other examples, the first copolymer phase includes other components in addition to the second carboxylic acid functional monomer and the ethylenically unsaturated monomer. In one of these examples, the first copolymer phase includes the second carboxylic acid functional monomer, the ethylenically unsaturated monomer, and the second (meth)acrylamide functional monomer (which is also present in the second copolymer phase), with no other components. In another example, the first copolymer phase includes the second carboxylic acid functional monomer, the ethylenically unsaturated monomer, and a third (meth)acrylamide functional monomer (which is different from the second (meth)acrylamide functional monomer present in the second copolymer phase), with no other components. In this example, the third (meth)acrylamide functional monomer may be any of the examples of the (first or second) (meth)acrylamide functional monomer described above. In still other examples, the first copolymer phase may include any combination of the listed monomers, along with a copolymerizable surfactant.

In some examples, the first copolymer phase may include up to 15 wt % of the second carboxylic acid functional monomer, based on the total weight of the first copolymer phase. In some examples, the first copolymer phase may include up to 12 wt %, up to 10 wt %, up to 5 wt %, or up to 3 wt % of the second carboxylic acid functional monomer, based on the total weight of the first copolymer phase. The lower end of these ranges may be at least 1 wt %, based on the total weight of the first copolymer phase. In other examples, the first copolymer phase may include up to 15 wt %, up to 12 wt %, up to 10 wt %, up to 5 wt %, or up to 3 wt %, of the second or third (meth)acrylamide functional monomer, based on the total weight of the first copolymer phase. The lower end of these ranges may also be at least 1 wt %, based on the total weight of the first copolymer phase. In still other examples, the first copolymer phase may include at least 70 wt %, at least 80 wt %, at least 85 wt %, at least 90 wt %, or at least 95 wt % of the ethylenically unsaturated monomer(s), based on the total weight of the first copolymer phase.

When the first copolymer phase includes both the second carboxylic acid functional monomer and the (meth)acrylamide functional monomer, it is to be understood that the second copolymer phase may include ethylenically unsaturated monomer(s) and a polymerizable surfactant without any of the functional monomers disclosed herein. In these examples, the first copolymer phase may include up to 30 wt % of the first carboxylic acid functional monomer and the first (meth)acrylamide functional monomer, based on a total weight of the first copolymer phase, and at least 70 wt % of other ethylenically unsaturated monomer(s), based on the total weight of the first copolymer phase. However, when the first copolymer phase includes the carboxylic acid functional monomer without the (meth)acrylamide functional monomer, then the second polymeric phase includes at least the (meth)acrylamide functional monomer.

In some examples then, the second copolymer phase consists of the second (meth)acrylamide functional monomer and an ethylenically unsaturated monomer, with no other components.

In other examples, the second copolymer phase includes other components in addition to the second (meth)acrylamide functional monomer and ethylenically unsaturated monomer. In one of these examples, the second copolymer phase consists of the second (meth)acrylamide functional monomer, the ethylenically unsaturated monomer, and the second carboxylic acid functional monomer (which is also present in the first copolymer phase), with no other components. In another example, the second copolymer phase consists of the second (meth)acrylamide, the ethylenically unsaturated monomer, and a third carboxylic acid functional monomer (which is different from the second carboxylic acid functional monomer present in the first copolymer phase), with no other components. In this example, the third carboxylic acid functional monomer may be any of the examples of the (first or second) carboxylic acid functional monomer described above. In still other examples, the second copolymer phase may include any combination of the listed monomers, along with a copolymerizable surfactant.

In any of these examples, the second copolymer phase may include up to 15 wt % of the second (meth)acrylamide functional monomer, based on the total weight of the second copolymer phase. In some examples, the second copolymer phase may include up to 12 wt %, up to 10 wt %, up to 5 wt %, or up to 3 wt % of the second (meth)acrylamide functional monomer, based on the total weight of the second copolymer phase. The lower end of these ranges may be at least 1 wt %, based on the total weight of the second copolymer phase. In other examples, the second phase may include up to 15 wt %, up to 10 wt %, up to 5 wt %, or up to 3 wt % of the second or third carboxylic acid functional monomer, based on the total weight of the second copolymer phase. The lower end of these ranges may also be at least 1 wt %, based on the total weight of the second copolymer phase. In still other examples, the second phase may include at least 70 wt %, at least 80 wt %, at least 85 wt %, at least 90 wt %, or at least 95 wt % of the ethylenically unsaturated monomer(s), based on the total weight of the second copolymer phase.

When the second copolymer phase includes both the carboxylic acid functional monomer and the (meth)acrylamide functional monomer, it is to be understood that the first copolymer phase may include ethylenically unsaturated monomer(s) and a polymerizable surfactant without any of the functional monomers disclosed herein. In these examples, the second copolymer phase may include up to 30 wt % of the first carboxylic acid functional monomer and the first (meth)acrylamide functional monomer, based on a total weight of the second copolymer phase, and at least 70 wt % of other ethylenically unsaturated monomer(s), based on the total weight of the second copolymer phase. However, when the second copolymer phase includes the (meth)acrylamide functional monomer without the carboxylic acid functional monomer, then the first polymeric phase includes at least the carboxylic acid functional monomer.

In one specific example, the latex binder particles include the multiple non-crosslinked copolymer phases; the multiple non-crosslinked copolymer phases include the first copolymer phase and the second copolymer phase; the first copolymer phase includes: the second carboxylic acid functional monomer and an ethylenically unsaturated monomer; or the second carboxylic acid functional monomer, the second (meth)acrylamide functional monomer, and an ethylenically unsaturated monomer; or the second carboxylic acid functional monomer, a third (meth)acrylamide functional monomer, and an ethylenically unsaturated monomer; and the second copolymer phase includes: the second (meth)acrylamide functional monomer and an ethylenically unsaturated monomer; or the second (meth)acrylamide functional monomer, the second carboxylic acid functional monomer, and an ethylenically unsaturated monomer; or the second (meth)acrylamide functional monomer, a third carboxylic acid functional monomer, and an ethylenically unsaturated monomer. Any of these examples may further include a polymerizable surfactant.

When the multi-phase latex particles include additional phases (e.g., a third phase, a fourth phase, etc.), each of the additional phases may be any example of the first copolymer phase or the second copolymer phase disclosed herein. When the first and/or second copolymer phases include the (meth)acrylamide functional monomer and the carboxylic acid functional monomer, it is to be understood that the additional phases may include the ethylenically unsaturated monomer(s) and the polymerizable surfactant, with or without the functional monomer(s) disclosed herein. As such, the description of the first and second copolymer phases also applies for any of the additional phases.

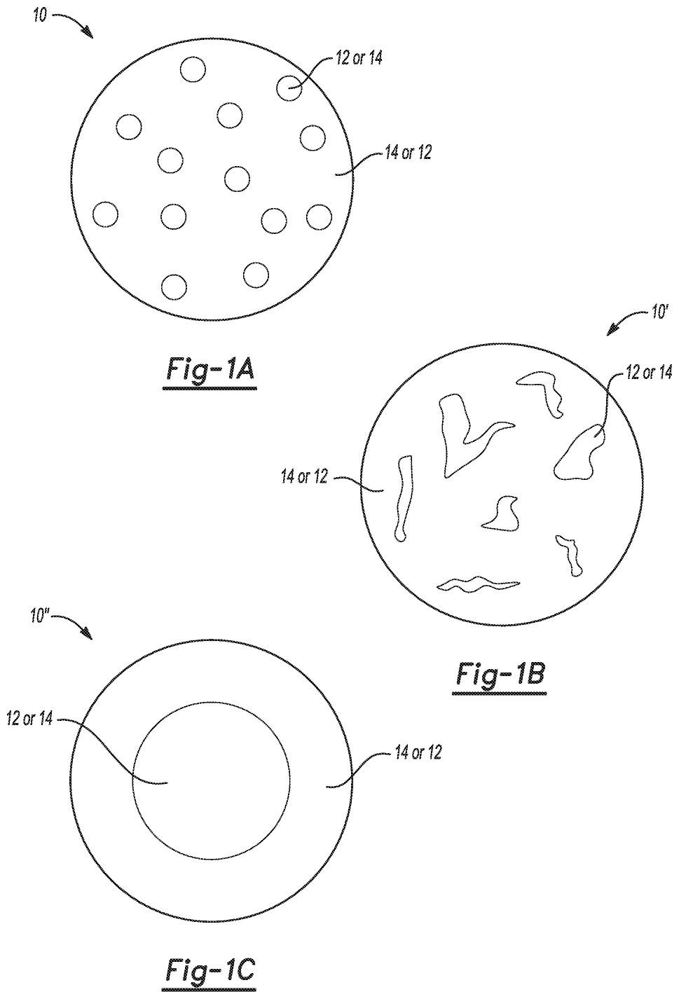

Referring now to FIG. 1A through FIG. 1C, various examples of the multiple phase particles 10, 10′, 10″ are schematically depicted. It is to be understood that the designations “12 or 14” and “14 or 12” indicate that when the first copolymer phase 12 makes up one phase, the second copolymer phase 14 makes up the other phase. As such, in FIG. 1A, the first copolymer phase 12 may form the phase that is surrounded by the second copolymer phase 14, or the second copolymer phase 14 may form the phase that is surrounded by the first copolymer phase 12. Moreover, while a few example morphologies are schematically illustrated, it is to be understood that the two copolymer phases 12, 14 may reside together in any physically separated configuration.

FIG. 1A through FIG. 1C schematically illustrate different morphologies of the multiphase particles 10, 10′, 10″. For any of the morphologies, the first copolymer phase 12 is physically separated from the second copolymer phase 14 within the polymer particle 10, 10′, 10″. The physical separation of the copolymer phases 12, 14 may manifest itself in a number of different ways. The first copolymer phase 12 may be interdispersed and incompletely coalesced among the second copolymer phase 14, as shown in FIG. 1A and FIG. 1B. In FIG. 1A, the first copolymer phase 12 forms substantially uniform spheres distributed throughout the second copolymer phase 14. In FIG. 1B, the first copolymer phase 12 forms randomly shaped strands distributed throughout the second copolymer phase 14. In addition to the examples shown in FIG. 1A and FIG. 1B, it is to be understood that any interdispersed and/or incompletely coalesced arrangement of the copolymer phases 12, 14 is contemplated as being suitable for the multiphase particle 10, 10′, 10″ morphology. Alternatively, the first copolymer phase 12 may form a core that is located within a continuous or discontinuous shell formed of the second phase 14. Still further, the second copolymer phase 14 may form a core that is located within a continuous or discontinuous shell formed of the first copolymer phase 12. While not shown, some examples of other possible morphologies include the copolymer phases 12, 14 separated into hemispheres, or one of the copolymer phases 12 or 14 present as small nodes at the surface of a sphere of the other of the phases 14 or 12. As previously mentioned, the morphologies described (whether shown or not shown) are not intended to limit the various physical separations of the phases 12, 14 that are possible. As such, any physical separation of the copolymer phases 12, 14 within the multiphase particles 10, 10′, 10″ is possible.

In some examples, the latex binder particles are not crosslinked. In some of these examples, the single copolymer phase is not crosslinked; or the multiple copolymer phases are not crosslinked; or (when both particle types are used in an ink) both the single copolymer phase and the multiple copolymer phases are not crosslinked. The non-crosslinked copolymer phases may include any example of the carboxylic acid functional monomer and/or the (meth)acrylamide functional monomer, and also include any example of the ethylenically unsaturated monomer(s). The ranges set forth herein are applicable for the non-crosslinked latex binder particles.

In some examples, the latex binder particles have an average glass transition temperature (Tg) ranging from −50° C. to about 30° C. In other examples, the latex binder particles have an average Tg ranging from −40° C. to about 30° C., from −30° C. to about 30° C., from 0° C. to about 30° C., or from 0° C. to about 25° C. In another example, the latex binder particles have an average Tg of about −15° C. The latex binder particles having an average glass transition temperature (Tg) within the ranges disclosed herein may enable a print generated with the inkjet ink on textile fabric to have a desirable feel or pliability/stiffness (commonly referred to as “hand”). In some examples, the latex binder particles, the components thereof, and the amounts of the components thereof may be selected, at least in part, to achieve a desired average glass transition temperature (Tg).

The glass transition temperature (Tg) of the copolymers may be estimated using the Fox equation (T. G. Fox, Bull. Am. Physics Soc., Volume 1, Issue No. 3, page 123 (1956)). The Tg of the homopolymer corresponding to each monomer incorporated into a given copolymer phase 12, 14, etc. may be taken from literature values (for example as listed in “Polymer Handbook”, edited by J. Brandrup, E. H. Immergut, and E. A. Grulke, Wiley Publishers, 4^{th} edition). The glass transition temperature (Tg) of the multiple copolymer phases may also be determined using DSC (differential scanning calorimetry) according to ASTM D3418. Using ASTM D3418 to measure the individual Tgs of the different copolymer phases in a multi-phase latex particle may be less desirable, in part because the data can be affected by the heating history of the actual DSC sample to determine the Tg and the glass transition ranges for the individual copolymer phases may overlap.

In some examples, the latex binder particles have a weight average particle size ranging from about 50 nm to about 400 nm. In other examples, which may be particularly suitable for thermal inkjet inks, the latex binder particles have a weight average particle size ranging from about 100 nm to about 400 nm, from about 100 nm to about 300 nm, from about 150 nm to about 350 nm, from about 200 nm to about 300 nm, from about 200 nm to about 350 nm, or from about 250 nm to about 350 nm. The latex binder particles having a weight average particle size within the ranges disclosed herein contribute to the good jettability of the inkjet ink.

In an example, the latex binder particles may be formed using multiple streams (e.g., monomer streams) in a reactor. Prior to the addition of any stream, water and a polymerization seed may be added to the reactor. A seed introduces small, pre-formed polymer particles (e.g., formed by a separate emulsion polymerization or other polymerization process) that replaces early particle formation stages by becoming the locus of polymerization. The seed particle(s) grow through additional polymerization in and/or on the seed, and there may be a one to one relationship of the number of seeds to the number of final latex binder particles. The use of polymer seeds permits accurate and reproducible particle size control. In an example, the polymer seed may be a (meth)acrylic copolymer. In another example, polymer seed may have a particle size of about 65 nm or lower.

An initiator may also be added to or included with the water and polymer seed. It is to be understood that the initiator dissolved in water may also be added to the reactor throughout the reaction process. Examples of suitable initiators include persulfate, such as a metal persulfate or an ammonium persulfate. In some examples, the initiator may be selected from a sodium persulfate, ammonium persulfate, or potassium persulfate. Other examples of suitable initiators include azo compounds, such as 1,1′-azobis(cyclohexanecarbonitrile), azobisisobutyronitrile, 2,2′-azobis(2-methylpropionitrile), and 2,2′-azobis(2-methylpropionitrile). Still other examples of suitable initiators include inorganic peroxides, such as hydroxymethane sulfinic acid monosodium salt dehydrate, and dicumyl peroxide. Yet other examples of suitable initiators include organic peroxides, such as tert-butyl hydroperoxide, tert-butyl peracetate, cumene hydroperoxide, 2,5-di(tert-butylperoxy)-2,5-dimethyl-3-hexyne, LUPEROX® 101, (2,5-bis(tert-butylperoxy)-2,5-dimethylhexane commercially available from Arkema Inc.), LUPEROX® 101XL45 (2,5-bis(tert-butylperoxy)-2,5-dimethylhexane commercially available from Arkema Inc.), LUPEROX® 224 (2,4-pentanedione peroxide commercially available from Arkema Inc.), LUPEROX® 231 (1,1-bis(tert-butylperoxy)-3,3,5-trimethylcyclohexane commercially available from Arkema Inc.), LUPEROX® 331M80 (1,1-bis(tert-butylperoxy)cyclohexane commercially available from Arkema Inc.), LUPEROX® 531M80 (1,1-bis(tert-amylperoxy)cyclohexane commercially available from Arkema Inc.), LUPEROX® DI (tert-butyl peroxide commercially available from Arkema Inc.), LUPEROX® P (tert-butyl peroxybenzoate commercially available from Arkema Inc.), LUPEROX® TBEC (tert-butylperoxy 2-ethylhexyl carbonate commercially available from Arkema Inc.), and LUPEROX® TBH70X (tert-butyl hydroperoxide commercially available from Arkema Inc.). Other examples of suitable organic peroxides include LUPEROX® A70S, LUPEROX® A75, LUPEROX® A75FP, LUPEROX® A98, LUPEROX® AFR40, LUPEROX® ATC50, each of which includes benzoyl peroxide and is commercially available from Arkema Inc. Still other examples of suitable organic peroxides include LUPEROX® DDM-9 and LUPEROX® DHD-9, each of which includes 2-butanone peroxide and is commercially available from Arkema Inc.

In some examples, the single copolymer phase may be formed. In one of these examples, two streams are concurrently added to the reactor. One of the two steams is composed of the monomers with low water solubility and in most cases will include at least the first carboxylic acid functional monomer, the first (meth)acrylamide functional monomer, and the other ethylenically unsaturated monomer(s). Another of the two streams includes an aqueous solution of a copolymerizable surfactant (e.g., surfactants from the HITENOL® AR series or the HITENOL® KH series or the HITENOL® BC series, e.g. HITENOL® AR-10, AR-20, KH-05, KH-10, BC-10, or BC-30). While several examples of surfactants have been provided, it is to be understood that another copolymerizable surfactant may be used, or a non-polymerizable surfactant may be used. If any of the monomers have significant water solubility, these monomers may be included in the aqueous feed stream along with the surfactant(s). These streams may be added over a targeted feed time, and may be allowed to react at a predetermined temperature for a predetermined time. In an example, the targeted feed time ranges from about 60 minutes to about 150 minutes. In another example the predetermined temperature is about 77° C. In still another example, the predetermined time is about 30 minutes. While some examples have been given, it is to be understood that other feed times, temperatures, and reaction times may be used.

In another example, these two streams (i.e., the monomer stream and the aqueous surfactant stream) may be combined into an oil-in-water pre-emulsion, and the pre-emulsion may be fed into the reactor as a single stream over the course of the reaction feed time.

In still another example, the first carboxylic acid monomer, the first (meth)acrylamide monomer and/or the ethylenically unsaturated monomer(s) could be separated into separate monomer feed streams. Each of the monomer streams may be paired with a separate aqueous surfactant stream. In this example, each pair (i.e., one of the monomer streams and one of the aqueous surfactant streams) could be fed into the reactor at a particular time (e.g., the first pair of streams followed by the second pair of streams, etc.). Alternatively, in this example, each pair could be combined into its own pre-emulsion, and the pre-emulsions may be fed into the reactor sequentially (i.e., one before the other).

In some examples, the multiple copolymer phases may be formed. Generally, this may be performed by feeding multiple monomer feed streams with different compositions of monomers subsequently to one another, rather than concurrently.

The following examples may be used to form the first copolymer phase 12. In one specific example, a monomer stream including at least the second carboxylic acid monomer and the ethylenically unsaturated monomer to form the first copolymer phase 12 and an aqueous surfactant stream may be concurrently added to the reactor. In another example, the monomer stream includes the second carboxylic acid monomer, the ethylenically unsaturated monomer, and the second or third (meth)acrylamide monomer. In another example, these two streams (i.e., the monomer stream and the aqueous surfactant stream) may be combined into an oil-in-water pre-emulsion, and the pre-emulsion may be fed into the reactor as a single stream over the course of the reaction feed time. In still another example, the second carboxylic acid monomer, the ethylenically unsaturated monomer, and (in some instances) the second or third (meth)acrylamide monomer could be separated into separate monomer feed streams. Each of the monomer streams may be paired with a separate aqueous surfactant stream. In this example, each pair (i.e., one of the monomer streams and one of the aqueous surfactant streams) could be fed into the reactor at a particular time (e.g., the first pair of streams followed by the second pair of streams). Alternatively, in this example, each pair could be combined into its own pre-emulsion, and the pre-emulsions may be fed into the reactor sequentially (i.e., one before the other). In any of these examples, the stream(s) may be added over a targeted feed time, and may be allowed to react at a predetermined temperature for a predetermined time. In an example, the targeted feed time ranges from about 60 minutes to about 150 minutes. In another example the predetermined temperature is about 77° C. In still another example, the predetermined time is about 30 minutes. While one example has been given, it is to be understood that other feed times, temperatures, and reaction times may be used.

After the feed(s) for forming the first phase 12 are finished using any of the examples mentioned herein (e.g., two streams, a pre-emulsion stream, etc.), another monomer stream is introduced to form the second copolymer phase 14. This other monomer stream may be an aqueous emulsion including at least the second (meth)acrylamide monomer and the ethylenically unsaturated monomer to form the second copolymer phase 14. In another example, the other monomer stream includes the second (meth)acrylamide monomer, the ethylenically unsaturated monomer, and the second or third carboxylic monomer. In addition to water and the various monomers, the other monomer stream may also include a copolymerizable surfactant. In still another example, the second (meth)acrylamide monomer, the ethylenically unsaturated monomer, and (in some instances) the second or third carboxylic monomer could be separated into separate monomer feed streams. Each of the monomer streams may be paired with a separate aqueous surfactant stream. In this example, each pair (i.e., one of the monomer streams and one of the aqueous surfactant streams) could be fed into the reactor at a particular time (e.g., the first pair of streams followed by the second pair of streams). Alternatively, in this example, each pair could be combined into its own pre-emulsion, and the pre-emulsions may be fed into the reactor sequentially (i.e., one before the other). In any of these examples, the other stream(s) may be added over a targeted feed time, and may be allowed to react at a predetermined temperature for a predetermined time. In an example, the targeted feed time ranges from about 60 minutes to about 150 minutes. In another example the predetermined temperature is about 77° C. In still another example, the predetermined time is about 30 minutes. While one example has been given, it is to be understood that other feed times, temperatures, and reaction times may be used.

Whether a single copolymer phase or multiple non-crosslinked copolymer phases are formed, the reaction temperature may vary depending, in part, on the initiator used. For persulfate initiated polymerizations of 5 to 6 hours time, the half-life of the polymerization may be taken into account. The reaction temperature determines, in part, the persulfate half-life.

The overall feed time may be longer or shorter, as desired in order to form the single copolymer phase particles or the multiphase polymer particles 10, 10′, 10″. In some examples when the multiphase polymer particles 10, 10′, 10″ are formed, the feed time may be proportional to the percentage of the phases 12, 14. For example, with a 5 hour feed time and a target composition for the multiphase polymer particle 10, 10′, 10″ including about 35 wt % of the first phase 12 and about 65 wt % of the second phase 14, the monomers for the first phase 12 may be fed for 35% of the 5 hour period (about 105 minutes) and the monomers for the second phase 14 may be fed for 65% of the 5 hour period (about 195 minutes). It is to be understood that other feed times may be used that are unrelated to the percentage of the phases 12, 14 in the polymer particles 10, 10′, 10″.

The reaction product includes the single phase particles or the multiphase particles 10, 10′, 10″ in an aqueous dispersion. In an example, the latex may include from about 10% solids to about 60% solids, or from about 30% solids to about 50% solids, or from about 40% solids to about 50% solids, based on the total weight of the latex. The viscosity of the latex (the latex binder particles in the aqueous dispersion) may be less than 50 cps, or less than 20 cps (when measured at 25° C. and 50 rpm with a Brookfield viscometer). The viscosity of the latex may also be higher, as it can be diluted to lower solids so that the ink is within a desirable range for the inkjet printhead being used. The pH of the latex may be from pH 2 to pH 10, or from 5 to 9. The acid value (mg KOH per g polymer) may range from about 2 to about 115, and will depend upon the amount of the carboxylic acid functional monomer that is used.

In some examples, the latex binder particles are present in the inkjet ink in an amount ranging from about 2 wt % active to about 15 wt % active, based on a total weight of the inkjet ink. In other examples, the latex binder particles are present in the inkjet ink in an amount ranging from about 6 wt % active to about 8 wt % active, based on the total weight of the inkjet ink. In still another example, the latex binder particles are present in the inkjet ink in an amount of about 6 wt % active, based on the total weight of the inkjet ink.

Liquid (Ink) Vehicles

In addition to the pigment and the latex binder particles, the inkjet ink includes a liquid vehicle (sometimes referred to as an ink vehicle).

As used herein, the term “liquid vehicle” may refer to the liquid with which the pigment (dispersion) and latex are mixed to form the inkjet ink(s) of the present disclosure. The liquid vehicle may include water and any of: a co-solvent, an anti-kogation agent, an anti-decel agent, a surfactant, an antimicrobial agent, a pH adjuster, or combinations thereof. As such, in some examples, the inkjet ink further comprises an additive selected from the group consisting of a non-ionic or an anionic surfactant, an anti-kogation agent, an antimicrobial agent, an anti-decel agent, and combinations thereof. In an example of the inkjet ink, the liquid vehicle includes water and a co-solvent. In another example, the liquid vehicle consists of water and the co-solvent, the anti-kogation agent, the anti-decel agent, the surfactant, the antimicrobial agent, a pH adjuster, or a combination thereof. In still another example, the liquid vehicle consists of the anti-kogation agent, the anti-decel agent, the surfactant, the antimicrobial agent, a pH adjuster, and water.

The liquid vehicle may include co-solvent(s). The co-solvent(s) may be present in an amount ranging from about 4 wt % to about 30 wt % (based on the total weight of the inkjet ink). In an example, the total amount of co-solvent(s) present in the inkjet ink is about 6 wt % (based on the total weight of the inkjet ink).

In an example, the liquid vehicle includes glycerol. Other examples of co-solvents include aliphatic alcohols, aromatic alcohols, diols, glycol ethers, polyglycol ethers, lactams, formamides, acetamides, glycols, and long chain alcohols. Examples of these co-solvents include primary aliphatic alcohols, secondary aliphatic alcohols, 1,2-alcohols, 1,3-alcohols, 1,5-alcohols, 1,6-hexanediol or other diols (e.g., 1,5-pentanediol, 2-methyl-1,3-propanediol, etc.), ethylene glycol alkyl ethers, propylene glycol alkyl ethers, higher homologs (C₆-C₁₂) of polyethylene glycol alkyl ethers, triethylene glycol, tetraethylene glycol, tripropylene glycol methyl ether, N-alkyl caprolactams, unsubstituted caprolactams, 2-pyrrolidone, 1-methyl-2-pyrrolidone, N-(2-hydroxyethyl)-2-pyrrolidone, both substituted and unsubstituted formamides, both substituted and unsubstituted acetamides, and the like. Other examples of organic co-solvents include dimethyl sulfoxide (DMSO), isopropyl alcohol, ethanol, pentanol, acetone, or the like.

The co-solvent may also be a polyhydric alcohol or a polyhydric alcohol derivative. Examples of polyhydric alcohols may include ethylene glycol, diethylene glycol, propylene glycol, butylene glycol, triethylene glycol, 1,5-pentanediol, 1,2-hexanediol, 1,2,6-hexanetriol, glycerin, trimethylolpropane, and xylitol. Examples of polyhydric alcohol derivatives may include an ethylene oxide adduct of diglycerin.

The co-solvent may also be a nitrogen-containing solvent. Examples of nitrogen-containing solvents may include 2-pyrrolidone, 1-(2-hydroxyethyl)-2-pyrrolidone, N-methyl-2-pyrrolidone, cyclohexylpyrrolidone, and triethanolamine.

It is also to be understood that the co-solvent may include any combination of the examples disclosed herein.

An anti-kogation agent may also be included in the liquid vehicle of a thermal inkjet composition. Kogation refers to the deposit of dried ink on a heating element of a thermal inkjet printhead. Anti-kogation agent(s) is/are included to assist in preventing the buildup of kogation. In some examples, the anti-kogation agent may improve the jettability of the inkjet ink. The anti-kogation agent may be present in the inkjet ink in an amount ranging from about 0.1 wt % active to about 1.5 wt % active, based on the total weight of the inkjet ink. In an example, the anti-kogation agent is present in an amount of about 0.5 wt % active, based on the total weight of the inkjet ink.

Examples of suitable anti-kogation agents include oleth-3-phosphate (commercially available as CRODAFOS™ O3A or CRODAFOS™ N-3A) or dextran 500k. Other suitable examples of the anti-kogation agents include CRODAFOS™ HCE (phosphate-ester from Croda Int.), CRODAFOS® N10 (oleth-10-phosphate from Croda Int.), or DISPERSOGEN® LFH (polymeric dispersing agent with aromatic anchoring groups, acid form, anionic, from Clariant), etc. It is also to be understood that the anti-kogation agent may include any combination of the examples disclosed herein.

The liquid vehicle may include anti-decel agent(s). The anti-decel agent may function as a humectant. Decel refers to a decrease in drop velocity over time with continuous firing. In the examples disclosed herein, the anti-decel agent (s) is/are included to assist in preventing decel. In some examples, the anti-decel agent may improve the jettability of the inkjet ink. The anti-decel agent(s) may be present in an amount ranging from about 0.2 wt % active to about 5 wt % active (based on the total weight of the inkjet ink). In an example, the anti-decel agent is present in the inkjet ink in an amount of about 1 wt % active, based on the total weight of the inkjet ink.

An example of a suitable anti-decel agent is ethoxylated glycerin having the following formula:

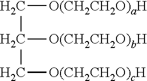

in which the total of a+b+c ranges from about 5 to about 60, or in other examples, from about 20 to about 30. An example of the ethoxylated glycerin is LIPON IC® EG-1 (LEG-1, glycereth-26, a+b+c=26, available from Lipo Chemicals).

The liquid vehicle of the inkjet ink may also include surfactant(s). In any of the examples disclosed herein, the surfactant may be present in an amount ranging from about 0.01 wt % active to about 5 wt % active (based on the total weight of the inkjet ink). In an example, the surfactant is present in the inkjet ink in an amount ranging from about 0.05 wt % active to about 3 wt % active, based on the total weight of the inkjet ink. In another example, the surfactant is present in the inkjet ink in an amount of about 0.3 wt % active, based on the total weight of the inkjet ink.

The surfactant may include anionic and/or non-ionic surfactants. Examples of the anionic surfactant may include alkylbenzene sulfonate, alkylphenyl sulfonate, alkylnaphthalene sulfonate, higher fatty acid salt, sulfate ester salt of higher fatty acid ester, sulfonate of higher fatty acid ester, sulfate ester salt and sulfonate of higher alcohol ether, higher alkyl sulfosuccinate, polyoxyethylene alkylether carboxylate, polyoxyethylene alkylether sulfate, alkyl phosphate, and polyoxyethylene alkyl ether phosphate. Specific examples of the anionic surfactant may include dodecylbenzenesulfonate, isopropylnaphthalenesulfonate, monobutylphenylphenol monosulfonate, monobutylbiphenyl sulfonate, monobutylbiphenylsulfonate, and dibutylphenylphenol disulfonate. Examples of the non-ionic surfactant may include polyoxyethylene alkyl ether, polyoxyethylene alkyl phenyl ether, polyoxyethylene fatty acid ester, sorbitan fatty acid ester, polyoxyethylene sorbitan fatty acid ester, polyoxyethylene sorbitol fatty acid ester, glycerin fatty acid ester, polyoxyethylene glycerin fatty acid ester, polyglycerin fatty acid ester, polyoxyethylene alkylamine, polyoxyethylene fatty acid amide, alkylalkanolamide, polyethylene glycol polypropylene glycol block copolymer, acetylene glycol, and a polyoxyethylene adduct of acetylene glycol. Specific examples of the non-ionic surfactant may include polyoxyethylenenonyl phenylether, polyoxyethyleneoctyl phenylether, and polyoxyethylenedodecyl. Further examples of the non-ionic surfactant may include silicon surfactants such as a polysiloxane oxyethylene adduct; fluorine surfactants such as perfluoroalkylcarboxylate, perfluoroalkyl sulfonate, and oxyethyleneperfluoro alkylether; and biosurfactants such as spiculisporic acid, rhamnolipid, and lysolecithin.

In some examples, the liquid vehicle may include a silicone-free alkoxylated alcohol surfactant such as, for example, TEGO® Wet 510 (Evonik Degussa) and/or a self-emulsifiable wetting agent based on acetylenic diol chemistry, such as, for example, SURFYNOL® SE-F (Evonik Degussa). Other suitable commercially available surfactants include SURFYNOL® 465 (ethoxylatedacetylenic diol), SURFYNOL® 440 (an ethoxylated low-foam wetting agent) SURFYNOL® CT-211 (now CARBOWET® GA-211, non-ionic, alkylphenylethoxylate and solvent free), and SURFYNOL® 104 (non-ionic wetting agent based on acetylenic diol chemistry), (all of which are from Evonik Degussa); ZONYL® FSO (a.k.a. CAPSTONE®, which is a water-soluble, ethoxylated non-ionic fluorosurfactant from DuPont); TERGITOL® TMN-3 and TERGITOL® TMN-6 (both of which are branched secondary alcohol ethoxylate, non-ionic surfactants), and TERGITOL® 15-S-3, TERGITOL® 15-S-5, and TERGITOL® 15-S-7 (each of which is a secondary alcohol ethoxylate, non-ionic surfactant) (all of the TERGITOL® surfactants are available from The Dow Chemical Company); and BYK® 345, BYK® 346, BYK® 347, BYK® 348, BYK® 349 (each of which is a silicone surfactant) (all of which are available from BYK Chemie).

It is also to be understood that the surfactant may include any combination of the examples disclosed herein.

The liquid vehicle may also include antimicrobial agent(s). Antimicrobial agents are also known as biocides and/or fungicides. In an example, the total amount of antimicrobial agent(s) in the inkjet ink ranges from about 0.01 wt % active to about 0.05 wt % active (based on the total weight of the inkjet ink). In another example, the total amount of antimicrobial agent(s) in the inkjet ink is about 0.044 wt % active (based on the total weight of the inkjet ink). In some instances, the antimicrobial agent may be present in the pigment dispersion that is mixed with the liquid vehicle.

Examples of suitable antimicrobial agents include the NUOSEPT® (Ashland Inc.), UCARCIDE™ or KORDEK™ or ROCIMA™ (The Dow Chemical Company), PROXEL® (Arch Chemicals) series, ACTICIDE® B20 and ACTICIDE® M20 and ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (The Dow Chemical Company), and combinations thereof.

The liquid vehicle may also include a pH adjuster. A pH adjuster may be included in the inkjet ink to achieve a desired pH (e.g., 8.5) and/or to counteract any slight pH drop that may occur over time. In an example, the total amount of pH adjuster(s) in the inkjet ink ranges from greater than 0 wt % to about 0.1 wt % (based on the total weight of the inkjet ink). In another example, the total amount of pH adjuster(s) in the inkjet ink is about 0.03 wt % (based on the total weight of the inkjet ink).

Examples of suitable pH adjusters include metal hydroxide bases, such as potassium hydroxide (KOH), sodium hydroxide (NaOH), etc. In an example, the metal hydroxide base may be added to the inkjet ink in an aqueous solution. In another example, the metal hydroxide base may be added to the inkjet ink in an aqueous solution including 5 wt % of the metal hydroxide base (e.g., a 5 wt % potassium hydroxide aqueous solution).

Suitable pH ranges for examples of the inkjet ink can be from pH 7 to pH 11, from pH 7 to pH 10, from pH 7.2 to pH 10, from pH 7.5 to pH 10, from pH 8 to pH 10, 7 to pH 9, from pH 7.2 to pH 9, from pH 7.5 to pH 9, from pH 8 to pH 9, from 7 to pH 8.5, from pH 7.2 to pH 8.5, from pH 7.5 to pH 8.5, from pH 8 to pH 8.5, from 7 to pH 8, from pH 7.2 to pH 8, or from pH 7.5 to pH 8.

The balance of the inkjet ink is water. In an example, purified water or deionized water may be used. The water included in the inkjet ink may be: i) part of the pigment dispersion and/or the latex binder particles dispersion, ii) part of the liquid vehicle, iii) added to a mixture of the pigment dispersion and/or the latex binder particles dispersion and the liquid vehicle, or iv) a combination thereof. In some examples the inkjet ink is a thermal inkjet ink, and the liquid vehicle includes at least 70% by weight of water.

Pre-Treatment Composition

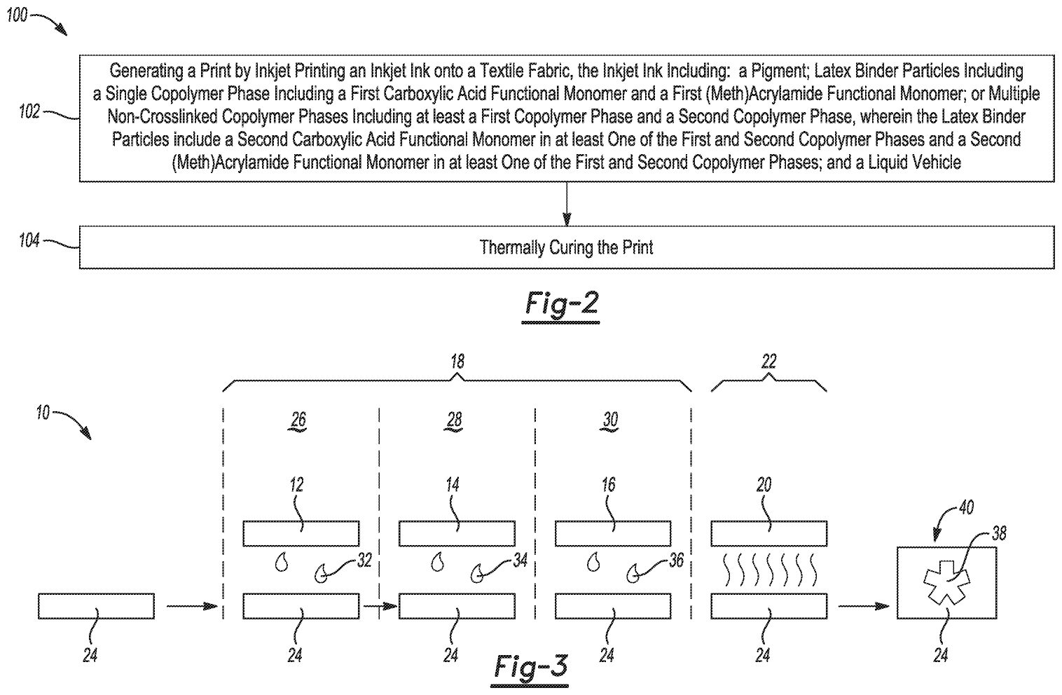

In some examples, the inkjet ink disclosed herein may be used with a pre-treatment composition. In an example of printing method (shown in FIG. 2) and for use in an example of a printing system (shown in FIG. 3), the pre-treatment composition includes a multivalent metal salt and an aqueous vehicle. In another example, the pre-treatment composition includes a cationic polymer and an aqueous vehicle. In still another example, the pre-treatment composition includes a multivalent metal salt, a cationic polymer, and an aqueous vehicle.

In some examples, the pre-treatment composition consists of the multivalent metal salt and/or the cationic polymer, and the aqueous vehicle. In other examples, the pre-treatment composition may include additional components.

Some examples of the pre-treatment composition disclosed herein may be used in an analog applicator, such as an auto analog pretreater, a drawdown coater, a slot die coater, a roller coater, a fountain curtain coater, a blade coater, a rod coater, an air knife coater, a sprayer, or a gravure application to pre-treat a textile fabric. The viscosity of the pre-treatment composition may be adjusted for the type coater that is to be used. As an example, when the pre-treatment composition is to be applied with an analog applicator, the viscosity of the pre-treatment composition may range from about 100 centipoise (cP) to about 300 cP (at 20° C. to 25° C. and about 100 rotations per minute (rpm)).

An example of the pre-treatment composition that may be applied with an analog applicator includes SURECOLOR® F2000 (a calcium-based pretreatment composition available from Seiko Epson Corporation). In another example, the SURECOLOR® F2000 may be diluted with water, for example, at a weight ratio (of SURECOLOR® F2000 to water) of 1:2.

Other examples of the pre-treatment composition disclosed herein may be used in a thermal inkjet printer or in a piezoelectric printer to pre-treat a textile fabric. The viscosity of the pre-treatment composition may be adjusted for the type of printhead that is to be used, and the viscosity may be adjusted by adjusting the co-solvent level and/or adding a viscosity modifier. When used in a thermal inkjet printer, the viscosity of the pre-treatment composition may be modified to range from about 1 cP to about 9 cP (at 20° C. to 25° C.), and when used in a piezoelectric printer, the viscosity of the pre-treatment composition may be modified to range from about 2 cP to about 20 cP (at 20° C. to 25° C.), depending on the type of the printhead that is being used (e.g., low viscosity printheads, medium viscosity printheads, or high viscosity printheads).

Multivalent Metal Salts

The multivalent metal salt includes a multivalent metal cation and an anion. In an example, the multivalent metal salt includes a multivalent metal cation selected from the group consisting of a calcium cation, a magnesium cation, a zinc cation, an iron cation, an aluminum cation, and combinations thereof; and an anion selected from the group consisting of a chloride anion, an iodide anion, a bromide anion, a nitrate anion, a carboxylate anion, a sulfonate anion, a sulfate anion, and combinations thereof. In one specific example, the multivalent metal includes a calcium cation. In another example, the multivalent metal includes a calcium cation; and an anion selected from the group consisting of a chloride anion, an iodide anion, a bromide anion, a nitrate anion, a carboxylate anion, a sulfonate anion, a sulfate anion, and combinations thereof.

It is to be understood that the multivalent metal salt (containing the multivalent metal cation) may be present in any suitable amount. In an example, the metal salt is present in an amount ranging from about 2 wt % to about 15 wt % based on a total weight of the pre-treatment composition. In further examples, the metal salt is present in an amount ranging from about 4 wt % to about 12 wt %; or from about 5 wt % to about 15 wt %; or from about 6 wt % to about 10 wt %, based on a total weight of the pre-treatment composition.

Cationic Polymer

In some examples (e.g., when the pre-treatment composition is to be thermal inkjet printed), the cationic polymer included in the pre-treatment composition has a weight average molecular weight of 100,000 or less. Any weight average molecular weight throughout this disclosure is in Daltons. This molecular weight enables the cationic polymer to be printed by thermal inkjet printheads. In some examples, the weight average molecular weight of the cationic polymer ranges from about 800 to about 40,000. It is expected that a cationic polymer with a weight average molecular weight higher than 100,000 can be used for examples of the pre-treatment composition applied by piezoelectric printheads and analog methods. As such, in other examples, the cationic polymer may have a weight average molecular weight higher than 100,000, such as, for example, up to 600,000.

Examples of the cationic polymer are selected from the group consisting of poly(diallyldimethylammonium chloride); poly(methylene-co-guanidine) anion, wherein the anion is selected from the group consisting of hydrochloride, bromide, nitrate, sulfate, and sulfonates; a polyamine; and poly(dimethylamine-co-epichlorohydrin).

In an example, the cationic polymer is present in an amount ranging from about 1 wt % active to about 10 wt % active based on a total weight of the pre-treatment composition. In further examples, the cationic polymer is present in an amount ranging from about 4 wt % active to about 8 wt % active; or from about 2 wt % active to about 7 wt % active; or from about 6 wt % active to about 10 wt % active, based on a total weight of the pre-treatment composition.

Aqueous (Pre-Treatment) Vehicles

As mentioned above, the pre-treatment composition also includes an aqueous vehicle. As used herein, the term “aqueous vehicle” may refer to the liquid in which the multivalent metal salt and/or cationic polymer is mixed to form the pre-treatment composition.

In an example of the pre-treatment composition, the aqueous vehicle includes a surfactant, a co-solvent, and a balance of water. In another example, the pre-treatment composition further comprises an additive selected from the group consisting of a chelating agent, an antimicrobial agent, an anti-kogation agent, a pH adjuster, and combinations thereof.

Some examples of the pre-treatment composition include a surfactant, a co-solvent, a chelating agent, an antimicrobial agent, and/or an anti-kogation agent. In these examples, the pre-treatment composition may include any of the examples of the surfactant, the co-solvent, the chelating agent, the antimicrobial agent, and/or the anti-kogation agent described above in reference to the liquid vehicle of the inkjet ink. In these examples, the pre-treatment composition may also include any of the surfactant, the co-solvent, the chelating agent, the antimicrobial agent, and/or the anti-kogation agent described above in reference to the liquid vehicle of the inkjet ink (with the amount(s) being based on the total weight of the pre-treatment composition rather than the total weight of the inkjet ink).

A pH adjuster may also be included in the pre-treatment composition. A pH adjuster may be included in the pre-treatment composition to achieve a desired pH (e.g., 6) and/or to counteract any slight pH increase that may occur over time. In an example, the total amount of pH adjuster(s) in the pre-treatment composition ranges from greater than 0 wt % to about 0.1 wt % (based on the total weight of the pre-treatment composition). In another example, the total amount of pH adjuster(s) in the pre-treatment composition is about 0.03 wt % (based on the total weight of the pre-treatment composition).

An example of a suitable pH adjuster that may be used in the pre-treatment composition includes methane sulfonic acid.

Suitable pH ranges for examples of the pre-treatment composition can be less than pH 7, from pH 5 to less than pH 7, from pH 5.5 to less than pH 7, from pH 5 to pH 6.6, or from pH 5.5 to pH 6.6. In one example, the pH of the pre-treatment composition is pH 6.

The balance of the pre-treatment composition is water. As such, the weight percentage of the water present in the pre-treatment composition will depend, in part, upon the weight percentages of the other components. The water may be purified water or deionized water.

Overcoat Composition

In some examples, the inkjet ink disclosed herein may be used with an overcoat composition. In an example of printing method (shown in FIG. 2) and for use in an example of a printing system (shown in FIG. 3), the overcoat composition includes a resin and an aqueous vehicle.

In some examples, the overcoat composition consists of the resin and the aqueous vehicle. In other examples, the overcoat composition may include additional components. Generally, the overcoat composition for not include a pigment or other colorant.

Some examples of the overcoat composition disclosed herein may be used in an analog applicator, such as an auto analog pretreater, a drawdown coater, a slot die coater, a roller coater, a fountain curtain coater, a blade coater, a rod coater, an air knife coater, a sprayer, or a gravure application to overcoat a printed textile fabric. The viscosity of the overcoat composition may be adjusted for the type coater that is to be used. As an example, when the overcoat composition is to be applied with an analog applicator, the viscosity of the overcoat composition may range from about 100 centipoise (cP) to about 300 cP (at 20° C. to 25° C. and about 100 rotations per minute (rpm)).

Other examples of the overcoat composition disclosed herein may be used in a thermal inkjet printer or in a piezoelectric printer to overcoat a printed textile fabric. The viscosity of the overcoat composition may be adjusted for the type of printhead that is to be used, and the viscosity may be adjusted by adjusting the co-solvent level and/or adding a viscosity modifier. When used in a thermal inkjet printer, the viscosity of the overcoat composition may be modified to range from about 1 cP to about 9 cP (at 20° C. to 25° C.), and when used in a piezoelectric printer, the viscosity of the overcoat composition may be modified to range from about 2 cP to about 20 cP (at 20° C. to 25° C.), depending on the type of the printhead that is being used (e.g., low viscosity printheads, medium viscosity printheads, or high viscosity printheads).

Resin

The resin in the overcoat may be any polymeric material that can form a durable, transparent film when dried (e.g., by heating). Any of the latex binder particles disclosed herein may be used in the overcoat composition. The ink and overcoat composition may have the same latex binder particles or different latex binder particles. Other types of latex may also be used. In still other examples, the resin may be a thermally curable polyurethane dispersion or a radiation curable polyurethane dispersion.

Aqueous (Overcoat) Vehicles

As mentioned above, the overcoat composition also includes an aqueous vehicle. As used herein, the term “aqueous vehicle” may refer to the liquid in which the resin is mixed to form the overcoat composition.

In an example of the overcoat composition, the aqueous vehicle includes a surfactant, a co-solvent, and a balance of water. In another example, the overcoat composition further comprises an additive selected from the group consisting of a chelating agent, an antimicrobial agent, an anti-kogation agent, a pH adjuster, and combinations thereof.

Some examples of the overcoat composition include a surfactant, a co-solvent, a chelating agent, an antimicrobial agent, and/or an anti-kogation agent. In these examples, the overcoat composition may include any of the examples of the surfactant, the co-solvent, the chelating agent, the antimicrobial agent, and/or the anti-kogation agent described above in reference to the liquid vehicle of the inkjet ink. In these examples, the overcoat composition may also include any of the surfactant, the co-solvent, the chelating agent, the antimicrobial agent, and/or the anti-kogation agent described above in reference to the liquid vehicle of the inkjet ink (with the amount(s) being based on the total weight of the overcoat composition rather than the total weight of the inkjet ink).

The balance of the overcoat composition is water. As such, the weight percentage of the water present in the overcoat composition will depend, in part, upon the weight percentages of the other components. The water may be purified water or deionized water.

Fluid Sets

The inkjet ink, the pre-treatment composition, and the overcoat composition described herein may be part of a fluid set. In an example, the fluid set comprises: a pre-treatment composition, including: a multivalent metal salt and a first aqueous vehicle; an inkjet ink, including: a pigment, latex binder particles consisting of: a single copolymer phase including a first carboxylic acid functional monomer and a first (meth)acrylamide functional monomer, or multiple copolymer phases including at least a first copolymer phase including a second carboxylic acid functional monomer and a second copolymer phase including a second (meth)acrylamide functional monomer, and a liquid vehicle; and an overcoat composition, including: a resin and a second aqueous vehicle.

In some examples, the fluid set disclosed herein includes multiple inkjet inks. In these examples, each of the aqueous inkjet inks may include a pigment, an example of the latex binder particles, and a liquid vehicle. However, each of the inkjet inks may include a different pigment or combination of pigments so that a different color (e.g., cyan, magenta, yellow, black, violet, green, brown, orange, purple, white, etc.) is generated by each of the inkjet inks. As an example, a combination of two or more inkjet inks selected from the group consisting of a cyan ink, a magenta ink, a yellow ink, and a black ink may be included in the fluid set.

In other examples, the fluid set disclosed herein may include a single aqueous inkjet ink.

In some examples, the fluid set includes or consists of the pre-treatment composition, the inkjet ink(s), and the overcoat composition. In other examples, the fluid set includes or consists of the pre-treatment composition and the inkjet ink(s). In still other examples, the fluid set includes or consists of the inkjet ink(s) and the overcoat composition. Any example of the fluid set may also be included in a textile printing kit with any example of the textile fabric disclosed herein.

It is to be understood that any example of the inkjet ink may be used in the examples of the fluid set. It is also to be understood that any example of the pre-treatment composition and/or any example of the overcoat composition may be used in the examples of the fluid set.

Textile Fabrics

In an example of a printing method (shown in FIG. 2) and for use in an example of a printing system (shown in FIG. 3), the textile fabric is selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof. In a further example, the textile fabric is selected from the group consisting of cotton fabrics and cotton blend fabrics.

It is to be understood that organic textile fabrics and/or inorganic textile fabrics may be used for the textile fabric. Some types of fabrics that can be used include various fabrics of natural and/or synthetic fibers. It is to be understood that the polyester fabrics may be a polyester coated surface. The polyester blend fabrics may be blends of polyester and other materials (e.g., cotton, linen, etc.). In another example, the textile fabric may be selected from nylons (polyamides) or other synthetic fabrics.

Example natural fiber fabrics that can be used include treated or untreated natural fabric textile substrates, e.g., wool, cotton, silk, linen, jute, flax, hemp, rayon fibers, thermoplastic aliphatic polymeric fibers derived from renewable resources (e.g. cornstarch, tapioca products, sugarcanes), etc. Example synthetic fibers used in the textile fabric/substrate can include polymeric fibers such as nylon fibers, polyvinyl chloride (PVC) fibers, PVC-free fibers made of polyester, polyamide, polyimide, polyacrylic, polypropylene, polyethylene, polyurethane, polystyrene, polyaramid (e.g., Kevlar®) polytetrafluoroethylene (Teflon®) (both trademarks of E.I. du Pont de Nemours and Company, Delaware), fiberglass, polytrimethylene, polycarbonate, polyethylene terephthalate, polyester terephthalate, polybutylene terephthalate, or a combination thereof. In some examples, the fiber can be a modified fiber from the above-listed polymers. The term “modified fiber” refers to one or both of the polymeric fiber and the fabric as a whole having undergone a chemical or physical process such as, but not limited to, copolymerization with monomers of other polymers, a chemical grafting reaction to contact a chemical functional group with one or both the polymeric fiber and a surface of the fabric, a plasma treatment, a solvent treatment, acid etching, or a biological treatment, an enzyme treatment, or antimicrobial treatment to prevent biological degradation.

It is to be understood that the terms “textile fabric” or “fabric substrate” do not include materials commonly known as any kind of paper (even though paper can include multiple types of natural and synthetic fibers or mixtures of both types of fibers). Fabric substrates can include textiles in filament form, textiles in the form of fabric material, or textiles in the form of fabric that has been crafted into finished articles (e.g., clothing, blankets, tablecloths, napkins, towels, bedding material, curtains, carpet, handbags, shoes, banners, signs, flags, etc.). In some examples, the fabric substrate can have a woven, knitted, non-woven, or tufted fabric structure. In one example, the fabric substrate can be a woven fabric where warp yarns and weft yarns can be mutually positioned at an angle of about 90°. This woven fabric can include fabric with a plain weave structure, fabric with twill weave structure where the twill weave produces diagonal lines on a face of the fabric, or a satin weave. In another example, the fabric substrate can be a knitted fabric with a loop structure. The loop structure can be a warp-knit fabric, a weft-knit fabric, or a combination thereof. A warp-knit fabric refers to every loop in a fabric structure that can be formed from a separate yarn mainly introduced in a longitudinal fabric direction. A weft-knit fabric refers to loops of one row of fabric that can be formed from the same yarn. In a further example, the fabric substrate can be a non-woven fabric. For example, the non-woven fabric can be a flexible fabric that can include a plurality of fibers or filaments that are one or both bonded together and interlocked together by a chemical treatment process (e.g., a solvent treatment), a mechanical treatment process (e.g., embossing), a thermal treatment process, or a combination of multiple processes.

Textile Printing Kit

The textile fabric, the pre-treatment composition, the inkjet ink, and/or the overcoat composition described herein may be part of a textile printing kit. In an example, the textile printing kit comprises: a textile fabric; a pre-treatment composition, including: a multivalent metal salt and a first aqueous vehicle; an inkjet ink, including: a pigment, latex binder particles consisting of: a single copolymer phase of a first carboxylic acid functional monomer and a first (meth)acrylamide functional monomer; or multiple copolymer phases including at least a first copolymer phase including a second carboxylic acid functional monomer and a second copolymer phase including a second (meth)acrylamide functional monomer, and a liquid vehicle; and an overcoat composition, including: a resin and a second aqueous vehicle. In another example, the textile printing kit comprises: a textile fabric; and an inkjet ink, including: a pigment, latex binder particles consisting of: a single copolymer phase of a first carboxylic acid functional monomer and a first (meth)acrylamide functional monomer, or multiple copolymer phases including at least a first copolymer phase including a second carboxylic acid functional monomer and a second copolymer phase including a second (meth)acrylamide functional monomer, and a liquid vehicle.

It is to be understood that any example of the inkjet ink may be used in the examples of the textile printing kit. It is also to be understood that any example of the pre-treatment composition and/or any example of the overcoat composition may be used in the examples of the textile printing kit. Further, it is to be understood that any example of the fluid kit may be used in the examples of the textile printing kit.

It is to be understood that any example of the textile fabric may be used in the examples of the textile printing kit. In one specific example of the textile printing kit, the textile fabric is selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof.

Printing Method and System

FIG. 2 depicts an example of the printing method 100. As shown in FIG. 2, an example the printing method 100 comprises: generating a print by inkjet printing an inkjet ink onto a textile fabric, the inkjet ink including: a pigment; latex binder particles consisting of: a single copolymer phase of a first carboxylic acid functional monomer and a first (meth)acrylamide functional monomer; or multiple copolymer phases including at least a first copolymer phase including a second carboxylic acid functional monomer and a second copolymer phase including a second (meth)acrylamide functional monomer; and a liquid vehicle (as shown at reference numeral 102); and thermally curing the print (as shown at reference numeral 104).

It is to be understood that any example of the inkjet ink may be used in the examples of the method 100. It is also to be understood that any example of the pre-treatment composition and/or overcoat composition may be used in the examples of the method 100. Further, it is to be understood that any example of the textile fabric may be used in the examples of the method 100.

As shown in reference numeral 102 in FIG. 2, the method 100 includes generating the print.

In some examples, generating the print includes inkjet printing the inkjet ink directly onto the textile fabric. As such, no pre-treatment composition is applied on the textile fabric before the inkjet ink is printed. In these examples, the overcoat composition may or may not be applied on the ink layer.

In other examples, generating the print includes: applying a pre-treatment composition on a textile fabric to form a pre-treatment layer; inkjet printing an inkjet ink on the pre-treatment layer to form an ink layer, the inkjet ink, including: a pigment; latex binder particles consisting of: a single copolymer phase of a first carboxylic acid functional monomer and a first (meth)acrylamide functional monomer; or multiple copolymer phases including at least a first copolymer phase including a second carboxylic acid functional monomer and a second copolymer phase including a second (meth)acrylamide functional monomer; and a liquid vehicle; and applying an overcoat composition on the ink layer to form an overcoat layer.

In some examples of the method 100, generating the print includes applying the pre-treatment composition and/or the overcoat composition. The pre-treatment composition and/or the overcoat composition may be applied using an auto analog pretreater, a drawdown coater, a slot die coater, a roller coater, a fountain curtain coater, a blade coater, a rod coater, an air knife coater, a sprayer, or a gravure application. In these examples, the pre-treatment composition and/or the overcoat composition may be coated on all or substantially all of the textile fabric. As such, the pre-treatment layer that is formed and/or the overcoat layer that is formed may be a continuous layer that covers all or substantially all of the textile fabric.

In other examples, the pre-treatment composition and/or the overcoat composition may be applied using inkjet printing. In these examples, the pre-treatment composition and/or the overcoat composition may be printed at desirable areas. As such, the pre-treatment layer that is formed by the application of the pre-treatment composition and/or the overcoat layer that is formed by the application of the overcoat composition may be non-continuous. In other words, the pre-treatment layer may contain gaps where no pre-treatment composition is printed and/or the overcoat layer may contain gaps where no overcoat composition is printed.

As shown in reference numeral 102 in FIG. 2, generating the print includes inkjet printing the inkjet ink on the textile fabric. It is to be understood that the inkjet ink is printed at desirable areas. As such, the ink layer that is formed by the application of the inkjet ink may be non-continuous. In other words, the ink layer may contain gaps where no ink is printed.

In some examples, multiple inkjet inks may be inkjet printed onto the textile fabric. In these examples, each of the inkjet inks may include the pigment, an example of the latex binder particle, and the liquid vehicle. However, each of the inkjet inks may include a pigment so that a different color (e.g., cyan, magenta, yellow, black, violet, green, brown, orange, purple, white, etc.) is generated by each of the inkjet inks. As an example, a combination of two or more inkjet inks selected from the group consisting of a cyan ink, a magenta ink, a yellow ink, and a black ink may be inkjet printed onto the textile fabric.

In other examples, a single inkjet ink may be inkjet printed onto the textile fabric.

In some examples of the method 100, the pre-treatment composition and/or the overcoat composition are applied using inkjet printing. In one of these examples, the pre-treatment composition, the inkjet ink, and/or the overcoat composition are applied in a single pass. As an example of single pass printing, the cartridges of an inkjet printer respectively deposit each of the compositions during the same pass of the cartridges across the textile fabric. In other words, the pre-treatment composition, the inkjet ink, and the overcoat composition are applied sequentially one immediately after the other as the applicators (e.g., cartridges, pens, printheads, etc.) pass over the textile substrate. In other examples, the pre-treatment composition, the inkjet ink, and/or the overcoat composition may each be applied in separate passes.

In some examples of the method 100, the inkjet ink is printed onto the pre-treatment layer while the pre-treatment layer is wet, and/or the overcoat composition is printed onto the ink layer while the ink layer is wet. Wet on wet printing may be desirable because less pre-treatment composition may be applied during this process (as compared to when the pre-treatment composition is dried prior to ink application), and because the printing workflow may be simplified without the additional drying. In an example of wet on wet printing, the inkjet ink is printed onto the pre-treatment layer within a period of time ranging from about 0.01 second to about 30 seconds after the pre-treatment layer is printed, and/or the overcoat composition is printed onto the ink layer within a period of time ranging from about 0.01 second to about 30 seconds after the ink layer is printed. In further examples, a respective composition is printed onto the previously applied layer within a period of time ranging from about 0.1 second to about 20 seconds; or from about 0.2 second to about 10 seconds; or from about 0.2 second to about 5 seconds after the previously applied layer is printed. Wet on wet printing may be accomplished in a single pass.

In another example of the method 100, drying takes place after the application of one composition and before the application of the next composition. As such, the pre-treatment layer may be dried on the textile fabric before the inkjet ink is applied, and the ink layer may be dried before the overcoat composition is applied. It is to be understood that in this example, drying of the respective compositions may be accomplished in any suitable manner, e.g., air dried (e.g., at a temperature ranging from about 20° C. to about 80° C. for 30 seconds to 5 minutes), exposure to electromagnetic radiation (e.g. infra-red (IR) radiation for 5 seconds), and/or the like. When drying is performed, the compositions may be applied in separate passes to allow time for the drying to take place.

The pre-treatment composition, the inkjet ink, and/or the overcoat composition may be inkjet printed using any suitable inkjet applicator, such as a thermal inkjet printhead, a piezoelectric printhead, a continuous inkjet printhead, etc.

In some examples of the method 100, the inkjet printing of the pre-treatment composition, the inkjet ink, and/or the overcoat composition may be accomplished at high printing speeds. In an example, the inkjet printing of the pre-treatment composition, the inkjet ink, and/or the overcoat composition may be accomplished at a printing speed of at least 25 feet per minute (fpm). In another example, the pre-treatment composition, the inkjet ink, and/or the overcoat composition may be inkjet printed a printing speed ranging from 100 fpm to 1000 fpm. In still another example, the pre-treatment composition, the inkjet ink, and/or the overcoat composition may be inkjet printed a printing speed ranging from 400 fpm to 600 fpm.

As shown in reference numeral 104 in FIG. 1, the method 100 includes thermally curing the print. The thermal curing of the print may be accomplished by applying heat to the print. In an example of the method 100, the thermal curing involves heating the print to a temperature ranging from about 80° C. to about 200° C., for a period of time ranging from about 10 seconds to about 15 minutes. In another example, the temperature ranges from about 100° C. to about 180° C. In still another example, thermal curing is achieved by heating the print to a temperature of 150° C. for about 3 minutes.

Referring now to FIG. 3, a schematic diagram of a printing system 10 including inkjet printheads 12, 14, 16 in a printing zone 18 of the printing system 10 and a dryer 20 positioned in a fixation zone 22 of the printing system 10.

In one example, a textile fabric/substrate 24 may be transported through the printing system 10 along the path shown by the arrows such that the textile fabric 24 is first fed to the printing zone 18. In the printing zone 18, the textile fabric 24 is first transported through a pre-treatment zone 26 where an example of the pre-treatment composition 32 is inkjet printed directly onto the textile fabric 24 by the inkjet printhead 12 (for example, from a piezo- or thermal-inkjet printhead) to form a pre-treatment layer on the textile fabric 24. The pre-treatment layer disposed on the textile fabric 24 may be heated in the printing zone 18 (for example, the air temperature in the printing zone 14 may range from about 10° C. to about 90° C.) such that water may be at least partially evaporated from the pre-treatment layer. The textile fabric 24 is then transported through an ink zone 28 where an example of the inkjet ink 34 is inkjet printed directly onto the pre-treatment layer on the textile fabric 24 by the inkjet printhead 14 (for example, from a piezo- or thermal-inkjet printhead) to form an ink layer. The ink layer may be heated in the printing zone 18 (for example, the air temperature in the printing zone 14 may range from about 10° C. to about 90° C.) such that water may be at least partially evaporated from the ink layer. The textile fabric 24 is then transported through an overcoat zone 30 where an example of the overcoat composition 36 is inkjet printed directly onto the ink layer on the textile fabric 24 by the inkjet printhead 16 (for example, from a piezo- or thermal-inkjet printhead) to form an overcoat layer.

Rather than specific zones 26, 28, 30 where each of the compositions 32, 34, 36 is applied, it is to be understood that the printing system 10 may include one printing zone 18 where inkjet cartridges are moved across the textile fabric 24 to deposit the compositions 32, 34, 36 in a single pass or in multiple passes.

The textile fabric 24 (having the pre-treatment composition, the inkjet ink, and the overcoat composition printed thereon) may then be transported to the curing zone 22 where the compositions/layers are heated to cure the print. The heat is sufficient to bind the pigment onto the textile fabric 24. The heat to initiate curing may range from about 80° C. to about 200° C. The curing of the ink/print forms the printed article 40 including the image 38 formed on the textile fabric 24.

To further illustrate the present disclosure, examples are given herein. It is to be understood that these examples are provided for illustrative purposes and are not to be construed as limiting the scope of the present disclosure.

### EXAMPLES

### Example 1

One example latex and six comparative example latexes were prepared. The example and comparative example latexes included different polymer (latex) particles in an aqueous medium. The example latex was formed with both a carboxylic acid functional monomer and an acrylamide functional monomer. The comparative example latexes were formed with either a carboxylic acid functional monomer or a (meth)acrylamide functional monomer, but not both. The synthesis of each of the example and comparative examples is set forth herein, and Table 1 summarizes the percentage of the functional monomers used to prepare the example and comparative example latexes.

The glass transition temperature of each of the example and comparative example latex particles was calculated. The acid value of each of the example and comparative example latex particles was calculated from the monomer amounts. The particle size (mean diameter of the intensity distribution, MI=ΣIᵢdᵢ/ΣIᵢ, where d=size represented by the center (geometric progression) between any 2 sizes, I=intensity percent between sizes, “i” refers to individual channel or bin sizes; and Σ=symbol meaning that each operation is added to the next in the series to achieve a sum of all) of each of the example and comparative example latex particles was determined using a Nanotrac size analyzer. The percentage of solids (% solids) in each of the example and comparative example latexes was also determined. The pH of each of the example and comparative example latexes was also measured. These values are reported in Table 2.

Seed Latex:

A seed latex was used to control the particle size of the latex polymer. This seed latex was composed of a (meth)acrylic copolymer with a particle size of approximately 65 nm and a solids content of approximately 48%.

Ex. 1 Latex:

14.0 grams (g) of the seed latex plus 341.5 g of water were added to a 1 L round bottom flask. Thermostatic temperature control was employed throughout the process and the reactor was continuously flushed with nitrogen gas. The reactor was heated to 77° C. and then a mixture of 0.37 g of potassium persulfate (KPS) and 9.3 g of deionized water was added to the reactor and held for 5 minutes before starting the monomer feed. After 5 minutes, a feed of KPS solution (0.78 g in 46.4 g water) was started and fed continuously over 180 minutes. Concurrently with the start of the KPS feed, the monomer feed was fed over 150 minutes (273.6 g n-butyl acrylate (n-BA), 74.2 g styrene, 11.1 g of methacrylic acid (MAA), 11.1 g of acrylamide (AAM), 18.5 g HITENOL® AR-1025 and 78.9 g water). Afterwards, the reactor was held at 77° C. for 30 minutes. Next, a mixture of 0.77 g of 70% tert-butyl hydroperoxide in water plus 10.2 g water was added to the reactor, and then a solution of 0.77 g of iso-ascorbic acid in 8.8 g water was fed over 60 minutes, followed by cooling the reactor to room temperature. At room temperature, the pH was adjusted by adding 36.3 g of a 5% solution of KOH in water to the reactor over approximately 10 minutes. The Ex. 1 latex was then filtered using a 200 mesh sieve.

Comp. Ex. 2 Latex:

14.4 g of the seed latex plus 353.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feed. After 5 minutes, a feed of KPS solution (0.38 g in 48.0 g water) was started and fed continuously over 180 minutes. Concurrently with the start of the KPS feed, the monomer feed was fed over 150 minutes (290.6 g n-BA, 76.8 g styrene, 15.4 g of acetoacetoxyethyl methacrylate (AAEM), 19.2 g HITENOL® AR-1025 and 81.6 g water). Afterwards, the reactor was held at 77° C. for 30 minutes. Next, a mixture of 0.77 g of 70% tert-butyl hydroperoxide in water plus 10.2 g water was added to the reactor, and then a solution of 0.77 g of iso-ascorbic acid in 8.8 g water was fed over 60 minutes, followed by cooling the reactor to room temperature. At room temperature, the pH was adjusted by adding 12.1 g of a 5% solution of KOH in water to the reactor over approximately 10 minutes. The Comp. Ex. 2 latex was then filtered using a 200 mesh sieve.

Comp. Ex. 3 Latex:

14.4 g of the seed latex plus 353.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feed. After 5 minutes, a feed of KPS solution (0.38 g in 48.0 g water) was started, and fed continuously over 180 minutes. Concurrently with the start of the KPS feed, the monomer feed was fed over 150 minutes (290.6 g n-BA, 76.8 g styrene, 15.4 g of SIPOMER® WAM II (methacrylic monomer based on 46%-50% methacrylamidoethyl ethylene urea), 19.2 g HITENOL® AR-1025 and 81.6 g water). Afterwards, the reactor was held at 77° C. for 30 minutes. Next, a mixture of 0.77 g of 70% tert-butyl hydroperoxide in water plus 10.2 g water was added to the reactor, and then a solution of 0.77 g of iso-ascorbic acid in 8.8 g water was fed over 60 minutes, followed by cooling the reactor to room temperature. At room temperature, the pH was adjusted by adding 10.9 g of a 5% solution of KOH in water to the reactor over approximately 10 minutes. The Comp. Ex. 3 latex was then filtered using a 200 mesh sieve.

Comp. Ex. 4 Latex:

14.4 g of the seed latex plus 353.3 g of water and 11.1 g of a 5 wt % KOH solution were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feed. After 5 minutes, a feed of KPS solution (0.38 g in 47.7 g water) was started and fed continuously over 180 minutes. Concurrently with the start of the KPS feed, the monomer feed was fed over 150 minutes (285.2 g n-BA, 76.4 g styrene, 19.1 g of dimethylaminoethyl methacrylate (DMAEMA), 19.1 g HITENOL® AR-1025, and 81.1 g water). Afterwards, the reactor was held at 77° C. for 30 minutes. Next, a mixture of 0.77 g of 70% tert-butyl hydroperoxide in water plus 10.2 g water was added to the reactor, and then a solution of 0.77 g of iso-ascorbic acid in 8.8 g water was fed over 60 minutes, followed by cooling the reactor to room temperature. At room temperature, the pH was adjusted by adding 1.4 g of a 5% solution of KOH in water to the reactor over approximately 10 minutes. The Comp. Ex. 4 latex was then filtered using a 200 mesh sieve.

Comp. Ex. 5 Latex:

14.4 g of the seed latex plus 353.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feed. After 5 minutes, a feed of KPS solution (0.38 g in 48.0 g water) was started and fed continuously over 180 minutes. Concurrently with the start of the KPS feed, the monomer feed was fed over 150 minutes (286.8 g n-BA, 76.8 g styrene, 19.2 g of hydroxyethyl methacrylate (HEMA), 19.2 g HITENOL® and 81.6 g water). Afterwards, the reactor was held at 77° C. for 30 minutes. Next, a mixture of 0.77 g of 70% tert-butyl hydroperoxide in water plus 10.2 g water was added to the reactor, and then a solution of 0.77 g of iso-ascorbic acid in 8.8 g water was fed over 60 minutes, followed by cooling the reactor to room temperature. At room temperature, the pH was adjusted by adding 9.0 g of a 5% solution of KOH in water to the reactor over approximately 10 minutes. The Comp. Ex. 5 latex was then filtered using a 200 mesh sieve.

Comp. Ex. 6 Latex:

14.0 g of the seed latex plus 341.5 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feed. After 5 minutes, a feed of KPS solution (0.38 g in 48.0 g water) was started and fed continuously over 180 minutes. Concurrently with the start of the KPS feed, the monomer feed was fed over 150 minutes (284.7 g n-BA, 74.2 g styrene, 11.1 g of methacrylic acid (MAA), 18.5 g HITENOL® AR-1025 and 78.9 g water). Afterwards, the reactor was held at 77° C. for 30 minutes. Next, a mixture of 0.74 g of 70% tert-butyl hydroperoxide in water plus 9.9 g water was added to the reactor, and then a solution of 0.74 g of iso-ascorbic acid in 8.5 g water was fed over 60 minutes, followed by cooling the reactor to room temperature. At room temperature, the pH was adjusted by adding 21.9 g of a 5% solution of KOH in water to the reactor over approximately 10 minutes. The Comp. Ex. 6 latex was then filtered using a 200 mesh sieve.

Comp. Ex. 7 Latex:

14.2 g of the seed latex plus 347.0 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.4 g of deionized water was added to the reactor and held for 5 minutes before starting the monomer feed. After 5 minutes, a feed of KPS solution (0.38 g in 47.1 g water) was started and fed continuously over 180 minutes. Concurrently with the start of the KPS feed, the monomer feed was fed over 150 minutes (293.0 g n-BA, 75.4 g styrene, 7.5 g of methacrylic acid (MAA), 18.8 g HITENOL® AR-1025 and 80.1 g water). Afterwards, the reactor was held at 77° C. for 30 minutes. Next, a mixture of 0.77 g of 70% tert-butyl hydroperoxide in water plus 10.2 g water was added to the reactor, and then a solution of 0.77 g of iso-ascorbic acid in 8.8 g water was fed over 60 minutes, followed by cooling the reactor to room temperature. At room temperature, the pH was adjusted by adding 18.0 g of a 5% solution of KOH in water was fed to the reactor over approximately 10 minutes. The Comp. Ex. 7 latex was then filtered using a 200 mesh sieve.

TABLE 1

| Example | | | |
|---|---|---|---|
| and | | | |
| comparative | | | |
| example | MAA | | FM |
| latexes | wt % | FM | wt % |
| Ex. 1 latex | 3 | AAM | 3 |
| Comp. Ex. 2 | 0 | AAEM | 5 |
| latex | | | |
| Comp. Ex. 3 | 0 | SIPOMER ® | 4 |
| latex | | WAM II | |
| Comp. Ex. 4 | 0 | DMAEMA | 5 |
| latex | | | |
| Comp. Ex. 5 | 0 | HEMA | 5 |
| latex | | | |
| Comp. Ex. 6 | 3 | None | 0 |
| latex | | | |
| Comp. Ex. 7 | 2 | None | 0 |
| latex | | | |

TABLE 2

| Example and comparative example latexes | Calc. T_{g} | $\begin{matrix}Acid Value \\ ( \frac{mg KOH}{g polymer} )\end{matrix}$ | Particle Size (MI, nm) | % solids | pH |
|---|---|---|---|---|---|
| Ex. 1 latex | −15 | 19.5 | 305 | 40.0 | 7.8 |
| Comp. Ex. 2 | −15 | 0 | 250 | 40.8 | 8.1 |
| latex | | | | | |
| Comp. Ex. 3 | −15 | 0 | 297 | 40.8 | 7.9 |
| latex | | | | | |
| Comp. Ex. 4 | −15 | 0 | 276 | 38.8 | 7.9 |
| latex | | | | | |
| Comp. Ex. 5 | −15 | 0 | 268 | 40.7 | 7.6 |
| latex | | | | | |
| Comp. Ex. 6 | −15 | 19.5 | 271 | 40.7 | 7.7 |
| latex | | | | | |
| Comp. Ex. 7 | −15 | 13 | 274 | 40.7 | 7.7 |
| latex | | | | | |

The polymer (latex) particles from Ex. 1 latex was incorporated into a magenta ink vehicle to form Ex. 1 ink. The polymer (latex) particles from Comp. Ex. 2-7 latexes were incorporated into the same magenta ink vehicle to form, respectively Comp. Ex. 2-7 inks. The general formulation of the inks is shown in Table 3, with the wt % active of each component that was used (e.g., wt % active pigment), except for the antimicrobial agent, which is shown as the weight percentage of the “as is” 20% active solution. A 5 wt % potassium hydroxide aqueous solution was added to each of the inks until a pH of about 8.5 was achieved.

TABLE 3

| | | Example and |
|---|---|---|
| | | comparative |
| Ingredient | Specific Component | inks |
| Polymer (latex) | Ex. 1 latex or | 6 |
| Particles | Comp. Ex. 2-7 latexes | |
| Pigment dispersion | Magenta pigment dispersion | 3 |
| Co-solvent | Glycerol | 6 |
| Anti-kogation agent | CRODAFOS ® N3 acid | 0.5 |
| Anti-decel agent | LI PONIC ® EG-1 | 1 |
| Surfactant | SURFYNOL ® 440 | 0.3 |
| Antimicrobial agent | ACTICIDE ® B20 | 0.22 |
| Water | Deionized water | Balance |

The example and comparative example inks were thermal inkjet printed on cotton fabric at 3 dpp. Each print was cured at 150° C. for 3 minutes. These prints were used to evaluate the washfastness. In a separate test, various printability parameters were tested, including decap, % missing nozzles, drop weight, drop velocity, decel, and turn-on-energy.

Decap Performance

The decap performance of each of the inks was tested. To test the decap performance, a printhead was filled with the ink and a warm up line was printed. A predetermined amount of time (e.g., 1 second and 7 seconds) is allowed to pass before the ink was again ejected from the printhead. A number of lines are printed until a good line is formed. A score was then assigned based on the number of lines (often referred to as “spits”) that are printed before a good line is formed. A lower decap score indicates a lower number of lines to achieve a quality line, and thus higher quality firing of the nozzles after the waiting period, and also indicates less clogging, plugging, or retraction of the colorant from the drop forming region of the nozzle/firing chamber. Typically, as the wait time increases, the quality of the print degrades.

The results of the decap performance tests for each ink are shown in Table 4. The amount of time for which the test nozzles on the active printhead were idle (not firing) before starting to print test lines (i.e., exposed to air) is indicated in Table 4.

TABLE 4

| Example and | | |
|---|---|---|
| comparative example | Decap | Decap |
| inks | 1 second | 7 seconds |
| Ex. 1 ink | 11 | 45 |
| Comp. Ex. 2 ink | 18 | 28 |
| Comp. Ex. 3 ink | 15 | 50 |
| Comp. Ex. 4 ink | 25 | 35 |
| Comp. Ex. 5 ink | 21 | 32 |
| Comp. Ex. 6 ink | 12 | 18 |
| Comp. Ex. 7 ink | 15 | 21 |

In terms of decap performance, the Ex. 1 ink performed the best after 1 second of uncapped non-use. All of the inks performed worse at the longer decap time.

Drop Weight, Drop Velocity and % Missing Nozzles

The drop weight is measured by firing a known number of drops, measuring the weight of ink fired, and dividing the weight by the number of drops, and thus they represent average drop weight. The steady state drop weight is measured at ejection frequencies of 0 kHz to 6 kHz, and the high frequency drop weight is measured at 30 kHz. A drop weight within a set range can lead to good jettability performance. For example, from about 9.0 ng to about 12.0 ng is a good range for drop weight for an ink containing a magenta pigment and being ejected from an 11 ng nozzle size.

The drop velocity was measured by using lasers to track the movement of ink drops as they were jetted through the air from the printhead. A drop velocity within a set range can lead to good jettability performance. For example, from about 8 m/s to about 14 m/s is a good range for drop velocity.

The missing nozzles percentage, for each example ink and comparative example ink, was calculated by determining the percentage of nozzles that did not fire during the drop velocity test. A high missing nozzle percentage can lead to poor jettability performance.

The results of the steady-state drop weight, high-frequency drop weight, and drop velocity measurements, as well as the calculated missing nozzles percentage are shown below in Table 5.

TABLE 5

| Example and | Steady-State | High-Frequency | Drop | Missing |
|---|---|---|---|---|
| comparative example | Drop weight | Drop Weight | velocity | Nozzles |
| inks | (ng) | (ng) | (m/s) | (%) |
| Ex. 1 ink | 11.8 | 9.2 | 13.0 | 0 |
| Comp. Ex. 2 ink | 11.7 | 9.7 | 10.3 | 2.1 |
| Comp. Ex. 3 ink | 11.6 | 6.5 | 11.0 | 3.1 |
| Comp. Ex. 4 ink | 10.9 | 5.0 | 10.5 | 12.5 |
| Comp. Ex. 5 ink | 11.1 | 7.6 | 10.4 | 0 |
| Comp. Ex. 6 ink | 12.2 | 8.9 | 11.6 | 0 |
| Comp. Ex. 7 ink | 12.2 | 9.2 | 12.1 | 14.6 |

As depicted, Ex. 1 ink performed better than or comparable to each of the comparative example inks in terms of drop weight, drop velocity, and % missing nozzles.

Decel

In order to determine decel performance, each of the example and comparative inks were filled into a thermal inkjet print head and the drop velocity vs. firing time over 6 seconds was collected. The example and comparative inks were tested as initially prepared and also after aging for 2 weeks using the accelerated storage test conditions described for the velocity test. The accelerated storage (AS) or accelerated shelf life (ASL) conditions included a temperature of 60° C., and the example and comparative inks were stored in these conditions for one week. The loss in velocity is shown in Table 6.

TABLE 6

| Example and | Decel |
|---|---|
| comparative example | (i.e., Loss in Velocity) |
| inks | (m/s) |
| Ex. 1 ink | 0.0 |
| Comp. Ex. 2 ink | 0.8 |
| Comp. Ex. 3 ink | 0.0 |
| Comp. Ex. 4 ink | 2.6 |
| Comp. Ex. 5 ink | 1.0 |
| Comp. Ex. 6 ink | 1.5 |
| Comp. Ex. 7 ink | 1.0 |

As depicted, Ex. 1 ink performed the same as Comp. Ex. 3 ink and better than each of the other comparative example inks in terms of decel.

TOE Curves

Turn-On Energy (TOE) curves were created for each of Ex. 1 ink and Comp. Ex. 2-7 inks. Ex. 1 ink and Comp. Ex. 2, 3, 6, and 7 exhibited a slight deviation from the desirable curve but still acceptable, while Comp. Ex. 4 and 5 inks exhibited a greater deviation from the desirable curve.

The prints generated on the cotton fabric were also tested for optical density and washfastness.

Optical Density and Washfastness

The initial optical density (initial OD) of each print was measured. Then, each print was washed 5 times in a Kenmore 90 Series Washer (Model 110.289 227 91) with warm water (at about 40° C.) and detergent. Each print was allowed to air dry between each wash. Then, the optical density (OD after 5 washes) of each print was measured, and the percent change in optical density (%Δ OD) was calculated for each print.

“Washfastness,” as used herein, refers to the ability of a print on a fabric to retain its color after being exposed to washing. Washfastness can be measured in terms of the percent change in OD and ΔE. The term “ΔE,” as used herein, refers to the change in the L*a*b* values of a color (e.g., cyan, magenta, yellow, black, red, green, blue, white) after washing. ΔE was calculated by:

ΔECIE*=[(ΔL*)²+(Δa*)²(Δb*)²]^{0.5}

The results of the optical density and washfastness test for each ink are shown in Table 7.

TABLE 7

| Example and | OD | OD | | |
|---|---|---|---|---|
| comparative example | Before | After 5 | | |
| inks | Wash | Washes | %/ΔOD | ΔE_{CIE} |
| Ex. link | 1.038 | 1.027 | −1.0 | 2.8 |
| Comp. Ex. 2 ink | 0.996 | 0.909 | −8.7 | 5.1 |
| Comp. Ex. 3 ink | 1.013 | 0.964 | −4.8 | 5.3 |
| Comp. Ex. 4 ink | 0.977 | 0.918 | −6.0 | 6.8 |
| Comp. Ex. 5 ink | 1.021 | 0.908 | −11.1 | 6.3 |
| Comp. Ex. 6 ink | 1.005 | 0.946 | −5.9 | 3.6 |
| Comp. Ex. 7 ink | 1.035 | 0.957 | −7.5 | 5.4 |

Ex. 1 ink (with the combination of the carboxylic acid functional monomer and the acrylamide functional monomer had the best performance in terms of wash durability as judged by the combination of % change in optical density (%ΔOD) and color change (ΔE). Ex. 1 ink outperformed each of the Comp. Ex. 2-7 inks, this is interesting because Ex. 1 ink contains the combination of both a carboxylic acid functional monomer and an acrylamide functional monomer, while the comparative inks did not.

### Example 2

Eight example latexes and two comparative example latexes were prepared to probe the significance of combining a carboxylic acid functional monomer and an acrylamide functional monomer in the same latex. In this example, the example and comparative example latexes included different core-shell polymer (latex) particles in an aqueous medium. The core and shell of the example latexes included one or both of a carboxylic acid functional monomer and an acrylamide functional monomer. The comparative example latexes included no carboxylic acid functional monomer and no acrylamide functional monomer in the core, and either the carboxylic acid functional monomer or the acrylamide functional monomer in shell. The synthesis of each of the example and comparative examples is set forth herein, and Table 8 summarizes the percentage of the functional monomers used in each of the core and shell to prepare the example and comparative example latexes. Table 8 also illustrates the calculated glass transition temperature of the core and of the shell for each of the example and comparative example core/shell latex particles.

The acid value of each of the example and comparative example core/shell latex particles was calculated using the monomer amounts. The particle size (mean diameter of the intensity distribution, MI=ΣIᵢdᵢ/ΣIᵢ, where d=size represented by the center (geometric progression) between any 2 sizes, I=intensity percent between sizes, “i” refers to individual channel or bin sizes; and Σ=symbol meaning that each operation is added to the next in the series to achieve a sum of all) of each of the example and comparative example latex particles was determined using a Nanotrac size analyzer. The percentage of solids (% solids) in each of the example and comparative example latexes was also determined. The pH of each of the example and comparative example latexes was also measured. These values are reported in Table 9.

The same seed latex of Example 1 was used.

Ex. 8 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (223.0 g n-butyl acrylate (n-BA), 81.2 g styrene, 9.7 g acrylamide (AAM), 9.7 g methacrylic acid (MAA), 16.2 g HITENOL® AR-1025 and 69.0 g water). When the first monomer feed finished, the reactor was held at 77° C. for 30 minutes, and then the second monomer feed was fed over 60 minutes (50.8 g methylmethacrylate (MMA), 2.9 g n-BA, 1.7 g AAM, 1.7 g MAA, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature, and then 34.1 g of a 5% solution of KOH in water was fed to the reactor over 10 minutes. Ex. 8 latex was then filtered using a 200 mesh sieve.

Ex. 9 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (236.0 g n-BA, 81.2 g styrene, 3.3 g AAM, 3.3 g MAA, 16.2 g HITENOL® AR-1025 and 69.0 g water). When the first monomer feed finished, the reactor was held at 77° C. for 30 minutes, and then the second monomer feed was fed over 60 minutes (53.1 g MMA, 2.9 g n-BA, 0.6 g AAM, 0.6 g MAA, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature, and then 14.7 g of a 5% solution of KOH in water was fed to the reactor over 10 minutes. Ex. 9 latex was then filtered using a 200 mesh sieve.

Ex. 10 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (232.7 g n-BA, 81.2 g styrene, 9.7 g MAA, 16.2 g HITENOL® AR-1025 and 69.0 g water). When the first monomer feed finished, the reactor was held at 77° C. for 30 minutes, and then the second monomer feed was fed over 60 minutes (52.5 g MMA, 2.9 g n-BA, 1.7 g AAM, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature and then 21.2 g of a 5% solution of KOH in water was fed to the reactor over 10 minutes. Ex. 10 latex was then filtered using a 200 mesh sieve.

Ex. 11 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (232.7 g n-BA, 81.2 g styrene, 9.7 g AAM, 16.2 g HITENOL® AR-1025 and 69.0 g water). When the first monomer feed finished, the reactor was held at 77° C. for 30 minutes, and then the second monomer feed was fed over 60 minutes (52.5 g MMA, 2.9 g n-BA, 1.7 g MAA, 3.0 g HITENOL® AR-1025 and 11.5 g water). After the end of the second monomer feed the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature and then 14.5 g of a 5% solution of KOH in water was fed to the reactor over 10 minutes. Ex. 11 latex was then filtered using a 200 mesh sieve.

Ex. 12 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (239.4 g n-BA, 81.2 g styrene, 3.3 g MAA, 16.2 g HITENOL® AR-1025 and 69.0 g water). When the first monomer feed finished, the reactor was held at 77° C. for 30 minutes, and then the second monomer feed was fed over 60 minutes (52.5 g MMA, 2.9 g n-BA, 1.7 g AAM, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature, and then 13.8 g of a 5% solution of KOH in water was fed to the reactor over 10 minutes. Ex. 12 latex was then filtered using a 200 mesh sieve.

Ex. 13 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (239.4 g n-BA, 81.2 g styrene, 3.3 g AAM, 16.2 g HITENOL® AR-1025 and 69.0 g water). When the first monomer feed finished the reactor was held at 77° C. for 30 minutes, and then the second monomer feed was fed over 60 minutes (52.5 g MMA, 2.9 g n-BA, 1.7 g MAA, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature, and then 12.7 g of a 5% solution of KOH in water was fed to the reactor over 10 minutes. Ex. 13 latex was then filtered using a 200 mesh sieve.

Ex. 14 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (242.4 g n-BA, 81.2 g styrene, 16.2 g HITENOL® AR-1025 and 69.0 g water). When the first monomer feed finished, the reactor was held at 77° C. for 30 minutes, and then the second monomer feed was fed over 60 minutes (50.8 g MMA, 2.9 g n-BA, 1.7 g MAA, 1.7 g AAM, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature, and then 12.1 g of a 5% solution of KOH in water was fed to the reactor over 10 minutes. Ex. latex 14 was then filtered using a 200 mesh sieve.

Ex. 15 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (242.4 g n-BA, 81.2 g styrene, 16.2 g HITENOL® AR-1025 and 69.0 g water). When the first monomer feed finished, the reactor was held at 77° C. for 30 minutes, and then the second monomer feed was fed over 60 minutes (53.9 g MMA, 2.9 g n-BA, 0.6 g AAM, 0.6 g MAA, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature, and then 11.5 g of a 5% solution of KOH in water was fed to the reactor over 10 minutes. Ex. 15 latex was then filtered using a 200 mesh sieve.

Comp. Ex. 16 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (242.4 g n-BA, 81.2 g styrene, 16.2 g HITENOL® AR-1025 and 69.0 g water). When the first monomer feed finished, the reactor was held at 77° C. for 30 minutes, and then the second monomer feed was fed over 60 minutes (52.5 g MMA, 2.9 g n-BA, 1.7 g MAA, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature, and then 12.8 g of a 5% solution of KOH in water was fed to the reactor over 10 minutes. Comp. Ex. 16 latex was then filtered using a 200 mesh sieve.

Comp. Ex. 17 Latex:

14.4 g of the seed latex plus 351.3 g of water were added to a 1 L round bottom flask. Thermostatic temperature control was employed throughout the process and the reactor was continuously flushed with nitrogen gas. The reactor was heated to 77° C. and then a mixture of 0.38 g of potassium persulfate (KPS) and 9.6 g of deionized water was added to the reactor and held for 5 minutes before starting the monomer feeds. After 5 minutes, a feed of KPS solution (0.38 g in 47.7 g water) was started and fed continuously over 270 minutes. Concurrently with the start of the KPS feed, the first monomer feed was fed over 150 minutes (242.4 g n-BA, 81.2 g styrene, 16.2 g HITENOL® AR-1025 and 69.0 g water). When the first monomer feed finished, the reactor was held at 77° C. for 30 minutes, and then the second monomer feed was fed over 60 minutes (52.5 g MMA, 2.9 g n-BA, 1.7 g AAM, 3.0 g HITENOL® AR-1025 and 11.5 g water). After the end of the second monomer feed, the reactor was held at 77° C. for another 30 minutes until the KPS feed was complete. Next, a mixture of 0.76 g of 70% tert-butyl hydroperoxide in water plus 10.2 g water was added to the reactor, and then a solution of 0.76 g of iso-ascorbic acid in 8.8 g water was fed over 60 minutes. The reactor was then cooled to room temperature and then 10.2 g of a 5% solution of KOH in water was fed to the reactor over 10 minutes. Comp. Ex. 17 latex was then filtered using a 200 mesh sieve.

TABLE 8

| Example | | | | | | |
|---|---|---|---|---|---|---|
| and | Latex Particle Core | | | Latex Particle Shell | | |
| comparative | (85% of particles) | | | (15% of particles) | | |
| example | AAM | MAA | Calc. | AAM | MAA | Calc. |
| latexes | wt % | wt % | Tg | wt % | wt % | Tg |
| Ex. 8 latex | 3 | 3 | −15 | 3 | 3 | 100 |
| Ex. 9 latex | 1 | 1 | −15 | 1 | 1 | 100 |
| Ex. 10 latex | 0 | 3 | −15 | 3 | 0 | 100 |
| Ex. 11 latex | 3 | 0 | −15 | 0 | 3 | 100 |
| Ex. 12 latex | 0 | 1 | −15 | 3 | 0 | 100 |
| Ex. 13 latex | 1 | 0 | −15 | 0 | 3 | 100 |
| Ex. 14 latex | 0 | 0 | −15 | 3 | 3 | 100 |
| Ex. 15 latex | 0 | 0 | −15 | 1 | 1 | 100 |
| Comp. | 0 | 0 | −15 | 0 | 3 | 100 |
| Ex. 16 latex | | | | | | |
| Comp. | 0 | 0 | −15 | 3 | 0 | 100 |
| Ex. 17 latex | | | | | | |

TABLE 9

| Example and comparative example latexes | $\begin{matrix}Acid Value \\ ( \frac{mg KOH}{g polymer} )\end{matrix}$ | Particle Size (MI, nm) | % solids | pH |
|---|---|---|---|---|
| Ex. 8 latex | 19.5 | 367 | 40.1 | 7.7 |
| Ex. 9 latex | 6.5 | 279 | 41.2 | 7.9 |
| Ex. 10 latex | 16.6 | 274 | 40.6 | 7.9 |
| Ex. 11 latex | 2.9 | 300 | 40.7 | 8.0 |
| Ex. 12 latex | 5.5 | 256 | 40.9 | 8.0 |
| Ex. 13 latex | 2.9 | 260 | 41.1 | 8.0 |
| Ex. 14 latex | 2.9 | 256 | 40.8 | 7.9 |
| Ex. 15 latex | 1 | 254 | 40.9 | 8.0 |
| Comp. Ex. 16 | 2.9 | 250 | 40.8 | 7.9 |
| latex | | | | |
| Comp. Ex. 17 | 0 | 258 | 40.7 | 8.0 |
| latex | | | | |

The core/shell polymer (latex) particles from Ex. 8-15 latex were incorporated into a magenta ink vehicle to form, respectively, Ex. 8 ink through Ex. 15 ink. The core/shell polymer (latex) particles from Comp. Ex. 16 and 17 latexes were incorporated into the same magenta ink vehicle to form, respectively Comp. Ex. 16 and Comp. Ex. 17 inks. The general formulation of the inks was the same as shown in Table 3 of Example 1, and a 5 wt % potassium hydroxide aqueous solution was added to each of the inks until a pH of about 8.5 was achieved.

The example and comparative example inks were thermal inkjet printed on cotton fabric at 3 dpp. Each print was cured at 150° C. for 3 minutes. These prints were used to evaluate the washfastness. In a separate test, various printability parameters were tested, including decap, % missing nozzles, drop weight, drop velocity, decel, and turn-on-energy.

Each of the printability parameters was measured as described in Example 1. The results for decap, % missing nozzles, drop weight, drop velocity, and decel are set forth in Table 10.

TABLE 10

| | | | Steady- | High- | | | |
|---|---|---|---|---|---|---|---|
| Example and | | | State | Frequency | | | |
| comparative | | | Drop | Drop | Drop | Missing | |
| example | Decap | Decap | weight | Weight | velocity | Nozzles | Decel |
| inks | 1 sec. | 7 sec. | (ng) | (ng) | (m/s) | cm | (m/s) |
| Ex. 8 ink | 15 | 50 | 11.6 | 10.0 | 12.5 | 5.2 | 0 |
| Ex. 9 ink | 15 | 42 | 11.6 | 10.3 | 12.5 | 11.5 | 0 |
| Ex. 10 ink | 18 | 35 | 11.8 | 9.3 | 12.8 | 1.0 | 0 |
| Ex. 11 ink | 22 | 50 | 11.7 | 10.3 | 12.8 | 6.3 | 0 |
| Ex. 12 ink | 18 | 39 | 11.8 | 6.8 | 12.0 | 1.0 | 0 |
| Ex. 13 ink | 15 | 50 | 12.0 | 11.4 | 12.8 | 1.0 | 0 |
| Ex. 14 ink | 20 | 50 | 11.7 | 10.8 | 12.4 | 2.1 | 0 |
| Ex. 15 ink | 18 | 24 | 11.9 | 7.1 | 12.4 | 3.1 | 0 |
| Comp. | 16 | 24 | 12.0 | 11.8 | 12.3 | 11.5 | 0 |
| Ex. 16 ink | | | | | | | |
| Comp. | 18 | 50 | 11.8 | 7.8 | 12.6 | 2.1 | 0 |
| Ex. 17 ink | | | | | | | |

The results in Table 10 illustrate that all of the inks—example inks and comparative example inks—exhibited similar printability performance.

Turn-On Energy (TOE) curves were created for each of the inks and comparative example inks. Each of the curves for the example inks and the comparative example inks exhibited a slight deviation from the desirable curve.

The prints generated on the cotton fabric were also tested for optical density and washfastness as described in Example 1.

The results of the optical density and washfastness test for each ink are shown in Table 11.

TABLE 11

| | Print Cured at 80° C./3 min. | | | | Print Cured at 150° C./3 min. | | | |
|---|---|---|---|---|---|---|---|---|
| Example and | OD | OD | | | OD | OD | | |
| comparative | Before | After 5 | | | Before | After 5 | | |
| example inks | Wash | Washes | % ΔOD | ΔE | Wash | Washes | % ΔOD | ΔE |
| Ex. 8 ink | 1.044 | 0.767 | −26.5 | 9.5 | 1.037 | 0.983 | −5.3 | 2.9 |
| Ex. 9 ink | 1.027 | 0.804 | −21.7 | 9.6 | 1.027 | 0.980 | −4.6 | 2.8 |
| Ex. 10 ink | 1.031 | 0.838 | −18.7 | 7.1 | 1.030 | 0.943 | −8.4 | 3.2 |
| Ex. 11 ink | 1.028 | 0.876 | −14.8 | 6.1 | 1.036 | 0.979 | −5.5 | 2.6 |
| Ex. 12 ink | 1.033 | 0.842 | −18.5 | 8.5 | 1.032 | 0.906 | −12.2 | 5.7 |
| Ex. 13 ink | 1.036 | 0.854 | −17.6 | 7.6 | 1.052 | 0.940 | −10.7 | 3.6 |
| Ex. 14 ink | 1.024 | 0.829 | −19.0 | 9.0 | 1.028 | 0.896 | −12.8 | 4.7 |
| Ex. 15 ink | 1.035 | 0.838 | −19.0 | 8.1 | 1.041 | 0.875 | −15.9 | 7.0 |
| Comp. Ex. 16 ink | 1.034 | 0.831 | −19.6 | 8.1 | 1.030 | 0.830 | −19.5 | 8.0 |
| Comp. Ex. 17 ink | 1.037 | 0.796 | −23.2 | 8.0 | 1.041 | 0.874 | −16.0 | 6.4 |

All of the inks performed better in terms of optical density (%ΔOD) and washfastness (ΔE) when the print was cured at the higher temperature. However, the best performance was observed when there was a combination of both methacrylic acid (carboxylic acid functional monomer) and acrylamide (acrylamide functional monomer) in the latex composition (in the core and/or shell). Ex. 8 ink (including both the carboxylic and acrylamide functional monomers in both the core and shell), Ex. 9 ink (including both the carboxylic and acrylamide functional monomers in both the core and shell), and Ex. 11 ink (including the higher amount of the acrylamide functional monomer in the core and the higher amount of the carboxylic functional monomer in the shell) performed the best when the print was cured at the higher temperature. In contrast, Comp. Ex. 16 ink and Comp. Ex. 17 ink performed the worst. These latexes included either methacrylic acid or acrylamide in the shell (but not in combination), and included neither of the functional monomers in the core. Ex. 14 ink and Ex. 15 ink included both methacrylic acid and acrylamide in the shell phase, but not in the core. These inks performed slightly better than the comparative inks, and it is believed that because the shell represents 15% of the total polymer latex, the overall loading of the combined monomers could be increased to impart even more improved performance. Ex. 12 ink and Ex. 13 ink represent examples where the methacrylic acid and acrylamide functional monomers are separated into the different phases, namely the core and the shell. These inks performed better than most of the comparative examples, and it is believed that if the amount of methacrylic acid were increased in the core or if the combination were used in one or both of the two phases, the performance would be better.

Overall, the results in Example 2 illustrate that including methacrylic acid and acrylamide functional monomers together in one phase, together in both phases, or separate with one in each phase of multi-phase latex particles improves the wash durability of ink jet ink compositions in textile applications.

It is to be understood that the ranges provided herein include the stated range and any value or sub-range within the stated range, as if the value(s) or sub-range(s) within the stated range were explicitly recited. For example, a range from about 2 wt % active to about 15 wt % active, should be interpreted to include not only the explicitly recited limits of from about 2 wt % active to about 15 wt % active, but also to include individual values, such as about 2.15 wt % active, about 4.5 wt % active, 6.0 wt % active, 8.77 wt % active, 10.85 wt % active, 12.33 wt % active, etc., and sub-ranges, such as from about 3 wt % active to about 10.65 wt % active, from about 5 wt % active to about 12 wt % active, from about 6.35 wt % active to about 13.95 wt % active, etc. Furthermore, when “about” is utilized to describe a value, this is meant to encompass minor variations (up to +1-10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An inkjet ink for textile printing, the inkjet ink comprising:
a pigment;
latex binder particles including:
a single copolymer phase including a first carboxylic acid functional monomer and a first (meth)acrylamide functional monomer; or
multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases; and
a liquid vehicle.

2. The inkjet ink as defined in claim 1 wherein the latex binder particles include the single copolymer phase, and the single copolymer phase includes up to 30 wt % of the first carboxylic acid functional monomer and the first (meth)acrylamide functional monomer, based on a total weight of the single copolymer phase, and at least 70 wt % of an ethylenically unsaturated monomer, based on the total weight of the single copolymer phase.

3. The inkjet ink as defined in claim 1 wherein the latex binder particles include the single copolymer phase, and the single copolymer phase consists of the first carboxylic acid functional monomer, the first (meth)acrylamide functional monomer, and an ethylenically unsaturated monomer.

4. The inkjet ink as defined in claim 1 wherein the latex binder particles include the multiple non-crosslinked copolymer phases, having from about 10 wt % to about 90 wt % of the first copolymer phase and from about 10 wt % to about 90 wt % of the second copolymer phase.

5. The inkjet ink as defined in claim 1 wherein:
the latex binder particles include the multiple non-crosslinked copolymer phases;
the multiple non-crosslinked copolymer phases include the first copolymer phase and the second copolymer phase;
the first copolymer phase includes:
the second carboxylic acid functional monomer and an ethylenically unsaturated monomer; or
the second carboxylic acid functional monomer, the second (meth)acrylamide functional monomer, and an ethylenically unsaturated monomer; or
the second carboxylic acid functional monomer, a third (meth)acrylamide functional monomer, and an ethylenically unsaturated monomer; and
the second copolymer phase includes:
the second (meth)acrylamide functional monomer and an ethylenically unsaturated monomer; or
the second (meth)acrylamide functional monomer, the second carboxylic acid functional monomer, and an ethylenically unsaturated monomer; or
the second (meth)acrylamide functional monomer, a third carboxylic acid functional monomer, and an ethylenically unsaturated monomer.

6. The inkjet ink as defined in claim 1 wherein:
the first carboxylic acid functional monomer is selected from the group consisting of acrylic acid, methacrylic acid, 2-carboxyethyl acrylate, 3-(methacryloyloxy)propionic acid, itaconic acid, citraconic acid, fumaric acid, crotonic acid, maleic acid, and a combination thereof; or
the second carboxylic acid functional monomer is selected from the group consisting of acrylic acid, methacrylic acid, 2-carboxyethyl acrylate, 3-(methacryloyloxy)propionic acid, itaconic acid, citraconic acid, fumaric acid, crotonic acid, maleic acid, and a combination thereof.

7. The inkjet ink as defined in claim 1 wherein:
the first (meth)acrylamide functional monomer is selected from the group consisting of acrylamide, methacrylamide, n-methylolacrylamide, n-methylolmethacrylamide, a hydroxyalkyl acrylamide, 3-methoxypropyl acrylamide, n-butoxymethyl acrylamide, isobutoxymethyl acrylamide, diacetone acrylamide, and a combination thereof; or
the second (meth)acrylamide functional monomer is selected from the group consisting of acrylamide, methacrylamide, n-methylolacrylamide, n-methylolmethacrylamide, a hydroxyalkyl acrylamide, 3-methoxypropyl acrylamide, n-butoxymethyl acrylamide, isobutoxymethyl acrylamide, diacetone acrylamide, and a combination thereof.

8. The inkjet ink as defined in claim 1 wherein the latex binder particles have an average glass transition temperature (Tg) ranging from −50° C. to about 30° C.

9. The inkjet ink as defined in claim 1 wherein the latex binder particles have a weight average particle size ranging from about 50 nm to about 400 nm.

10. The inkjet ink as defined in claim 1 wherein the single copolymer phase is not crosslinked.

11. The inkjet ink as defined in claim 1 wherein the latex binder particles are present in an amount ranging from about 2 wt % active to about 15 wt % active, based on a total weight of the inkjet ink.

12. The inkjet ink as defined in claim 1 wherein the inkjet ink includes a combination of the latex binder particles including the single copolymer phase and of the latex binder particles including the multiple non-crosslinked copolymer phases.

13. An inkjet ink for textile printing, the inkjet ink comprising:
a pigment;
latex binder particles consisting of:
a non-crosslinked single copolymer phase including a first carboxylic acid functional monomer and a first (meth)acrylamide functional monomer; or
multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases; and
a liquid vehicle.

14. A textile printing kit, comprising:
a textile fabric; and
an inkjet ink, including:
a pigment;
latex binder particles including:
a single copolymer phase including a first carboxylic acid functional monomer and a first (meth)acrylamide functional monomer; or
multiple non-crosslinked copolymer phases including at least a first copolymer phase and a second copolymer phase, wherein the latex binder particles include a second carboxylic acid functional monomer in at least one of the first and second copolymer phases and a second (meth)acrylamide functional monomer in at least one of the first and second copolymer phases; and
a liquid vehicle.

15. The textile printing kit as defined in claim 14 wherein the textile fabric is selected from the group consisting of polyester fabrics, polyester blend fabrics, cotton fabrics, cotton blend fabrics, nylon fabrics, nylon blend fabrics, silk fabrics, silk blend fabrics, wool fabrics, wool blend fabrics, and combinations thereof.
